(19) United States
(12) Patent Application Publication
(10) Pub. No.: US 2013/0142161 A1
(43) Pub. Date: Jun. 6, 2013

(54) METHOD AND APPARATUS FOR TRANSMITTING CONTROL INFORMATION IN A WIRELESS COMMUNICATION SYSTEM

(71) Applicants: Hyunwoo Lee, Anyang-si (KR); Jaehoon Chung, Anyang-si (KR); Seunghee Han, Anyang-si (KR)

(72) Inventors: Hyunwoo Lee, Anyang-si (KR); Jaehoon Chung, Anyang-si (KR); Seunghee Han, Anyang-si (KR)

(73) Assignee: LG ELECTRONICS INC., Seoul (KR)

(21) Appl. No.: 13/816,923

(22) PCT Filed: Aug. 17, 2011
(86) PCT No.: PCT/KR2011/006030

§ 371 Date: Feb. 13, 2013

Related U.S. Application Data
(60) Provisional application No. 61/374,280, filed on Aug. 17, 2010.

(51) Int. Cl. H04W 72/04

(52) U.S. Cl. CPC H04W 72/0413
USPC 370/329

(57) ABSTRACT

The present invention relates to a wireless communication system, and more particularly, to a method and apparatus for transmitting control information. The wireless communication system may support carrier aggregation (CA). A method for a terminal to transmit control information to a base station in a wireless communication system comprises: a step of receiving a plurality of transmitting blocks from the base station via one or more serving cells constructed for the terminal; and a step of transmitting first control information regarding the received transport blocks to the base station, wherein each of the serving cells may carry one or more transport blocks, and the first control information may be information regarding each of the transport blocks contained in the respective serving cells.

### TECHNICAL FIELD

The present invention relates to a wireless communication system and, more particularly, to a method and apparatus for transmitting control information. The wireless communication system can support carrier aggregation (CA).

### BACKGROUND ART

Wireless communication systems have been developed to provide various types of communication services including voice and data services. In general, a wireless communication system is a multiple access system that supports communication with multiple users by sharing available system resources (e.g. bandwidth, transmit power, etc.). The multiple access system may adopt a multiple access scheme such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

### DISCLOSURE

### Technical Problem

An object of the present invention is to provide a method and apparatus for efficiently transmitting control information in a wireless communication system. Another object of the present invention is to provide a channel format, signal processing method and apparatus for efficiently transmitting control information. Another object of the present invention is to provide a method and apparatus for efficiently allocating resources for transmitting control information.

It will be appreciated by persons skilled in the art that the objects that could be achieved with the present invention are not limited to what has been particularly described hereinabove and the above and other objects that the present invention could achieve will be more clearly understood from the following detailed description taken in conjunction with the accompanying drawings.

### Technical Solution

The object of the present invention can be achieved by providing a method for a user equipment (UE) to transmit control information to a base station (BS) in a wireless communication system, the method including: receiving a plurality of transport blocks from the BS via at least one serving cell configured for the UE; and transmitting first control information regarding the received transport blocks to the BS, wherein each of the at least one serving cell carries one or more transport blocks, and the first control information is information regarding each of the one or more transport blocks included in each of the at least one serving cell.

The first control information may be information on the number of positive acknowledgement response (ACK).

The first control information may be information regarding each of a maximum number of transport blocks carried by each of the at least one serving cell and, when the number of transport blocks carried by a first serving cell from among the at least one serving cell is less than the maximum number of transport blocks, the first control information regarding each of transport blocks other than transport blocks actually carried by the first serving cell from among the maximum number of transport blocks carried by the first serving cell may be negative acknowledgement response (NACK) information.

The maximum number of transport blocks may be 2.

The transmitting of the first control information to the BS may include selecting a PUCCH resource for the first control information from a plurality of PUCCH resources, and transmitting a PUCCH signal carrying a modulation value corresponding to the first control information through the selected PUCCH resource, wherein the first control information is identified by a combination of the selected PUCCH resource and the modulation value.

The transmitting of the first control information to the BS may include transmitting a PUCCH signal carrying a modulation value corresponding to the first control information through a PUCCH resource, and transmitting a reference signal for demodulation of the PUCCH signal, wherein the first control information is identified by a combination of the modulation value and a resource for the reference signal.

The transmitting of the first control information to the BS may include selecting a PUCCH resource for the first control information from a plurality of PUCCH resources, transmitting a PUCCH signal carrying a modulation value corresponding to the first control information through the selected PUCCH resource, and transmitting a reference signal for demodulation of the PUCCH signal, wherein the first control information is identified by a combination of the selected PUCCH resource, the modulation value and a resource for the reference signal.

The object of the present invention can be achieved by providing a UE for transmitting control information to a BS in a wireless communication system, the UE including: a receiver for receiving a plurality of transport blocks from the BS via at least one serving cell configured for the UE; and a transmitter for transmitting first control information regarding the received transport blocks to the BS, wherein each of the at least one serving cell carries one or more transport blocks, and the first control information is information regarding each of the one or more transport blocks included in each of the at least one serving cell.

The first control information may be information on the number of positive acknowledgement response (ACK).

The UE may further include a processor. The first control information is information regarding each of a maximum number of transport blocks carried by the at least one serving cell and, when the number of transport blocks carried by a first serving cell from among the at least one serving cell is less than the maximum number of transport blocks, the processor controls the first control information regarding each of transport blocks other than transport blocks actually carried by the first serving cell from among a maximum number of transport blocks carried by the first serving cell to be negative acknowledgement response (NACK) information.

The maximum number of transport blocks may be 2.

The processor may select a PUCCH resource for the first control information from a plurality of PUCCH resources and control a PUCCH signal carrying a modulation value corresponding to the first control information to be transmitted through the selected PUCCH resource, wherein the first control information is identified by a combination of the selected PUCCH resource and the modulation value.

The processor may transmit a PUCCH signal carrying a modulation value corresponding to the first control information through a PUCCH resource via the transmitter and control a reference signal for demodulation of the PUCCH signal to be transmitted through the transmitter, wherein the first control information is identified by a combination of the modulation value and a resource for the reference signal.

The processor may select a PUCCH resource for the first control information from a plurality of PUCCH resources, transmit a PUCCH signal carrying a modulation value corresponding to the first control information through the selected PUCCH resource via the transmitter, and control a reference signal for demodulation of the PUCCH signal to be transmitted through the transmitter, wherein the first control information is identified by a combination of the selected PUCCH resource, the modulation value and a resource for the reference signal.

### Advantageous Effects

According to embodiments of the present invention, control information can be efficiently transmitted in a wireless communication system. Furthermore, a channel format and a signal processing method for efficiently transmitting control information can be provided. In addition, resources for control information transmission can be efficiently allocated.

It will be appreciated by persons skilled in the art that that the effects that can be achieved with the present invention are not limited to what has been particularly described hereinabove and other advantages of the present invention will be more clearly understood from the following detailed description taken in conjunction with the accompanying drawings.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a User Equipment (UE) and a Base Station (BS), to which the present invention is applied;

FIG. 2 illustrates a signal processing operation for transmitting an uplink signal at a UE;

FIG. 3 illustrates a signal processing operation for transmitting a downlink signal at a BS;

FIG. 4 illustrates Single Carrier Frequency Division Multiple Access (SC-FDMA) and Orthogonal Frequency Division Multiple Access (OFDMA), to which the present invention is applied;

FIG. 5 illustrates examples of mapping input symbols to subcarriers in the frequency domain in a manner that satisfies a single carrier property;

FIG. 6 illustrates a signal processing operation for mapping Discrete Fourier Transform (DFT) output samples to a single carrier in clustered SC-FDMA;

FIGS. 7 and 8 illustrate signal processing operations for mapping DFT output samples to multiple carriers in clustered SC-FDMA;

FIG. 9 illustrates a signal processing operation in segmented SC-FDMA;

FIG. 10 illustrates exemplary radio frame structures in a wireless communication system;

FIG. 11 illustrates an uplink subframe structure;

FIG. 12 illustrates a structure for determining a Physical Uplink Control CHannel (PUCCH) for ACKnowledgment/Negative ACKnowledgment (ACK/NACK) transmission;

FIGS. 13 and 14 illustrate slot-level structures of PUCCH Formats 1a and 1b for ACK/NACK transmission;

FIG. 15 illustrates PUCCH Format 2/2a/2b in case of a normal Cyclic Prefix (CP);

FIG. 16 illustrates PUCCH Format 2/2a/2b in case of an extended CP;

FIG. 17 illustrates ACK/NACK channelization for PUCCH Formats 1a and 1b;

FIG. 18 illustrates channelization for a hybrid structure of PUCCH Format 1/1a/1b and PUCCH Format 2/2a/2b in the same Physical Resource Block (PRB);

FIG. 19 illustrates PRB allocation;

FIG. 20 is a conceptual view illustrating DownLink Component Carrier (DL CC) management at a BS;

FIG. 21 is a conceptual view illustrating UpLink CC (UL CC) management at a UE;

FIG. 22 is a conceptual view illustrating multi-carrier management of one Medium Access Control (MAC) layer at a BS;

FIG. 23 is a conceptual view illustrating multi-carrier management of one MAC layer at a UE;

FIG. 24 is a conceptual view illustrating multi-carrier management of a plurality of MAC layers at a BS;

FIG. 25 is a conceptual view illustrating multi-carrier management of a plurality of MAC layers at a UE;

FIG. 26 is another conceptual view illustrating multi-carrier management of a plurality of MAC layers at a BS;

FIG. 27 is another conceptual view illustrating multi-carrier management of a plurality of MAC layers at a UE;

FIG. 28 illustrates asymmetrical Carrier Aggregation (CA) in which five DL CCs are linked to one UL CC;

FIGS. 29 to 32 illustrate the structure of PUCCH Format 3 and a signal processing operation for PUCCH Format 3, to which the present invention is applied;

FIG. 33 illustrates an ACK/NACK information transmission structure based on channel selection, to which the present invention is applied; and

FIG. 34 illustrates an ACK/NACK information transmission structure based on enhanced channel selection, to which the present invention is applied.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. In the following description, numerous specific details are set forth. However, it is understood that embodiments of the invention may be practiced without these specific details.

Embodiments of the present invention are applicable to a variety of wireless access technologies such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), Multi-Carrier Frequency Division Multiple Access (MC-FDMA), etc. CDMA can be implemented as a wireless technology such as Universal Terrestrial Radio Access (UTRA) or CDMA2000. TDMA can be implemented as a wireless technology such as Global System for Mobile communications (GSM)/General Packet Radio Service (GPRS)/Enhanced Data Rates for GSM Evolution (EDGE). OFDMA can be implemented as a wireless technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, Evolved UTRA (E-UTRA). UTRA is a part of Universal Mobile Telecommunications System (UMTS). 3^{rd} Generation Partnership Project (3GPP) Long Term Evolution (LTE) is a part of Evolved UMTS (E-UMTS) using E-UTRA. 3GPP LTE adopts OFDMA on downlink and adopts SC-FDMA on uplink. LTE-Advanced (LTE-A) is an evolution of 3GPP LTE. While the following description is given centering on 3GPP LTE/LTE-A for clarity of description, this is purely exemplary and thus should not be construed as limiting the present invention. For example, while the following detailed description is given under the assumption that a 3GPP LTE/LTE-A wireless communication system is used, the description is applicable to any other wireless communication system except for specific features inherent to the 3GPP LTE/LTE-A system.

In some instances, known structures and devices are omitted or are shown in block diagram form, focusing on important features of the structures and devices, so as not to obscure the concept of the invention. The same reference numbers will be used throughout this specification to refer to the same parts.

In the following description, a terminal generically refers to a mobile or fixed user terminal device for transmitting and receiving data and control information by communicating with a Base Station (BS). The term terminal may be replaced with the terms User Equipment (UE), Mobile Station (MS), Mobile Terminal (MT), Subscriber Station (SS), wireless device, Personal Digital Assistant (PDA), wireless modem, handheld device, etc.

In addition, a BS generically refers to any fixed station which communicates with a UE or another BS, for exchanging data and control information with the UE or another BS. The term BS may be replaced with the terms evolved Node B (eNB), Base Transceiver System (BTS), Access Point (AP), etc.

According to the present invention, allocation of a specific signal to a frame/subframe/slot/carrier/subcarrier means transmission of the specific signal on a corresponding carrier/subcarrier during the period of a corresponding frame/subframe/slot or at the timing of the corresponding frame/subframe/slot.

A rank or a transmission rank refers to the number of layers that are multiplexed or allocated to one Orthogonal Frequency Division Multiplexing (OFDM) symbol or one Resource Element (RE) in the present invention.

Physical Downlink Control CHannel (PDCCH), Physical Control Format Indicator CHannel (PCFICH), Physical Hybrid automatic repeat request Indicator CHannel (PHICH), and Physical Downlink Shared CHannel (PDSCH) are sets of REs that respectively carry Downlink Control Information (DCI), a Control Format Indicator (CFI), a downlink ACKnowledgment/Negative ACKnowledgment (ACK/NACK), and downlink data in the present invention.

Physical Uplink Control CHannel (PUCCH), Physical Uplink Shared CHannel (PUSCH), and Physical Random Access CHannel (PRACH) are sets of REs that respectively carry Uplink Control Information (UCI), uplink data, and a random access signal.

Especially, REs allocated to or belonging to the PDCCH, PCFICH, PHICH, PDSCH, PUCCH, PUSCH, and PRACH are referred to as PDCCH, PCFICH, PHICH, PDSCH, PUCCH, PUSCH, and PRACH REs or resources.

Accordingly, if it is said that a UE transmits a PUCCH, PUSCH, or PRACH, this may mean that the UE transmits UCI, uplink data, or a random access signal on the PUCCH, PUSCH, or PRACH. In addition, if it is said that a BS transmits a PDCCH, PCFICH, PHICH, or PDSCH, this may mean that the BS transmits DCI or downlink data on the PDCCH, PCFICH, PHICH, or PDSCH.

Mapping ACK/NACK information to a specific constellation point is equivalent to mapping ACK/NACK information to a specific complex modulation symbol. Mapping ACK/NACK information to a specific complex modulation symbol is also equivalent to modulating ACK/NACK information to a specific complex modulation symbol.

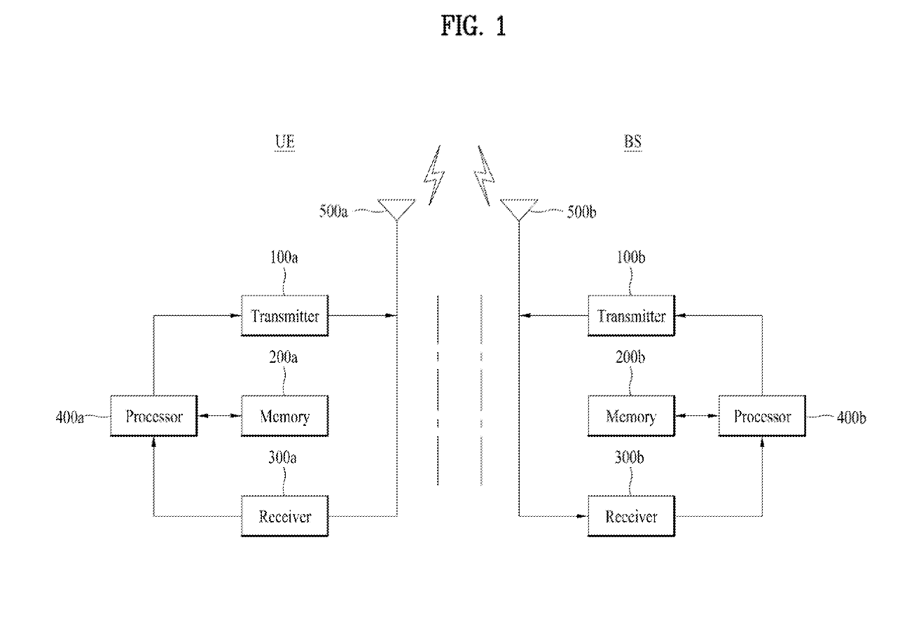

FIG. 1 illustrates configurations of a UE and a BS, to which the present invention is applied. The UE operates as a transmission device on uplink and as a reception device on downlink. On the contrary, the BS operates as a reception device on uplink and as a transmission device on downlink.

Referring to FIG. 1, the UE and the BS include antennas 500a and 500b for receiving information, data, signals, or messages, transmitters 100a and 100b for transmitting information, data, signals, or messages by controlling the antennas 500a and 500b, receivers 300a and 300b for receiving information, data, signals, or messages by controlling the antennas 500a and 500b, and memories 200a and 200b for temporarily or permanently storing various types of information in the wireless communication system. The UE and the BS further include processors 400a and 400b connected to the transmitters 100a and 100b, the receivers 300a and 300b, and the memories 200a and 200b for controlling each component.

The transmitter 100a, the receiver 300a, the memory 200a, and the processor 400a of the UE may be configured as independent components on respective chips or two or more thereof may be integrated into one chip. The transmitter 100b, the receiver 300b, the memory 200b, and the processor 400b of the BS may be configured as independent components on respective chips or two or more thereof may be integrated into one chip. The transmitter and the receiver may be integrated into a single transceiver in the UE or the BS.

The antennas 500a and 500b transmit signals generated from the transmitters 100a and 100b to the outside or receive signals from the outside and provide the received signals to the receivers 300a and 300b. The antennas 500a and 500b are also referred to as antenna ports. An antenna port may correspond to one physical antenna or a combination of a plurality of physical antennas. If a transmitter and a receiver support Multiple Input Multiple Output (MIMO) in which data is transmitted and received through a plurality of antennas, each thereof may be connected to two or more antennas.

The processor 400a or 400b generally provides overall control to the components or modules of the UE or the BS. Especially, the processors 400a and 400b may perform various control functions for implementing the present invention, a Medium Access Control (MAC) frame conversion control function based on service characteristics and a propagation environment, a power saving mode function for controlling an idle-mode operation, a handover function, an authentication and encryption function, etc. The processors 400a and 400b may be called controllers, microcontrollers, microprocessors, or microcomputers. Meanwhile, the processors 400a and 400b may be configured as hardware, firmware, software, or a combination thereof.

In a hardware configuration, the processors 400a and 400b may include Application Specific Integrated Circuits (ASICs), Digital Signal Processors (DSPs), Digital Signal Processing Devices (DSPDs), Programmable Logic Devices (PLDs), Field Programmable Gate Arrays (FPGAs), etc. which are configured to implement the present invention.

In a firmware or software configuration, firmware or software may be configured so as to include a module, a procedure, a function, etc. that perform the functions or operations of the present invention. The firmware or software configured to implement the present invention may be included in the processors 400a and 400b, or may be stored in the memories 200a and 200b and executed by the processors 400a and 400b.

The transmitters 100a and 100b encode and modulate signals or data scheduled by the processors 400a and 400b or schedulers connected to the processors 400a and 400b and transmitted to the outside, according to a predetermined coding and modulation scheme, and transmit the modulated signals or data to the antennas 500a and 500b. The transmitters 100a and 100b and the receivers 300a and 300b of the UE and the BS may be configured differently according to operations of processing a transmission signal and a received signal.

The memories 200a and 200b may store programs for processing and control in the processors 400a and 400b and may temporarily store input and output information. The memories 200a and 200b may be used as buffers. The memories 200a and 200b may be a flash memory, a hard disk, a multimedia card micro, a card type memory (e.g. a Secure Digital (SD) or eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disc, etc.

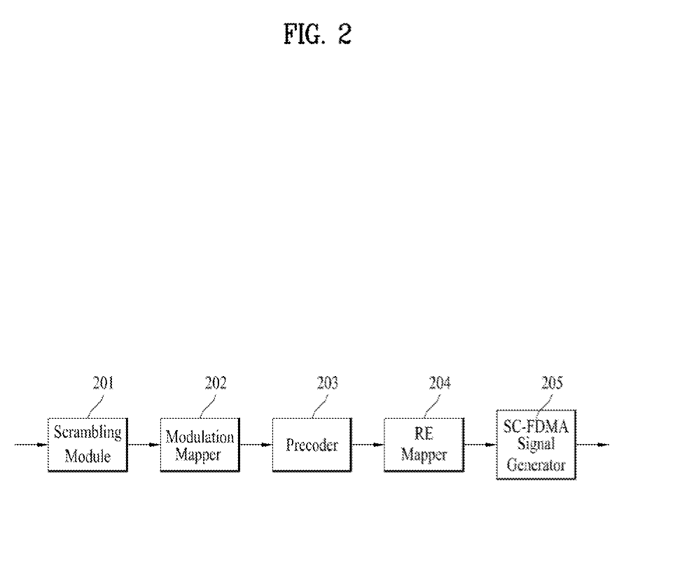

FIG. 2 illustrates a signal processing operation for transmitting an uplink signal at a UE. Referring to FIG. 2, the transmitter 100a of the UE may include a scrambling module 201, a modulation mapper 202, a precoder 203, an RE mapper 204, and an SC-FDMA signal generator 205.

The scrambling module 201 may scramble a transmission signal with a scrambling signal in order to transmit an uplink signal. The modulation mapper 202 modulates the scrambled signal received from the scrambling module 201 into complex modulation symbols in Binary Phase Shift Keying (BPSK), Quadrature Phase Shift Keying (QPSK), or 16-ary Quadrature Amplitude Modulation (16QAM)/64-ary QAM (64QAM) according to the type of the transmission signal or a channel state. The precoder 203 processes the complex modulation symbols received from the modulation mapper 202. The RE mapper 204 may map the complex modulation symbols received from the precoder 203 to time-frequency REs. After being processed in the SC-FDMA signal generator 205, the mapped signal may be transmitted to a BS through an antenna port.

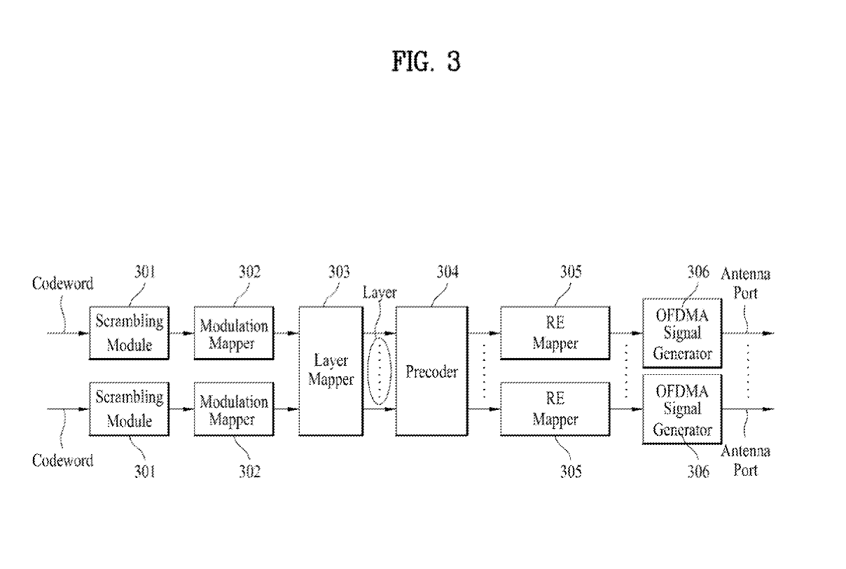

FIG. 3 illustrates a signal processing operation for transmitting a downlink signal at a BS. Referring to FIG. 3, the transmitter 100b of the BS may include scrambling modules 301, modulation mappers 302, a layer mapper 303, a precoder 304, RE mappers 305, and OFDMA signal generators 306.

To transmit a signal or one or more codewords on downlink, the scrambling modules 301 and the modulation mappers 302 may modulate the signal or the one or more codewords to complex modulation symbols, as is done on uplink in the signal processing operation illustrated in FIG. 2. The layer mapper 303 maps the complex modulation symbols to a plurality of layers. The precoder 304 may multiply the layers by a precoding matrix and may allocate the multiplied signals to respective transmission antennas. The RE mappers 305 map the antenna-specific signals received from the precoder 304 to time-frequency REs. After being processed in the OFDMA signal generators 306, the mapped signals may be transmitted through respective antenna ports.

In the wireless communication system, Peak-to-Average Power Ratio (PAPR) becomes a challenging issue to uplink signal transmission from a UE, relative to downlink signal transmission from a BS. Accordingly, SC-FDMA is adopted for uplink signal transmission, while OFDMA is used for downlink signal transmission, as described before with reference to FIGS. 2 and 3.

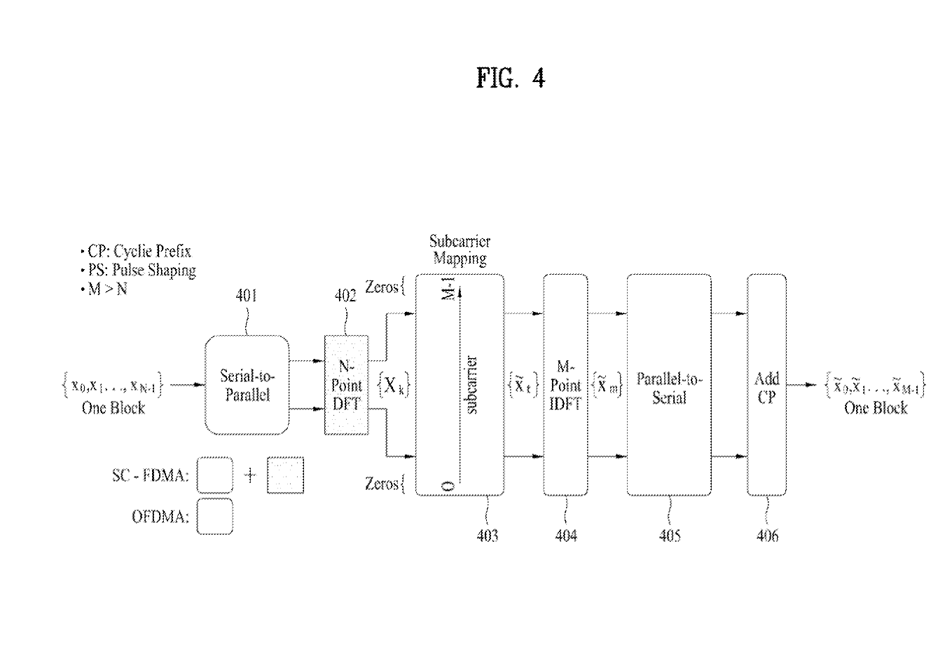

FIG. 4 illustrates SC-FDMA and OFDMA, to which the present invention is applied. The 3GPP system employs OFDMA for downlink and SC-FDMA for uplink.

Referring to FIG. 4, both a UE and a BS commonly have a Serial-to-Parallel Converter (SPC) 401, a subcarrier mapper 403, an M-point Inverse Discrete Fourier Transform (IDFT) module 404, and a Cyclic Prefix (CP) adder 406, for uplink signal transmission and downlink signal transmission. Notably, the UE further includes an N-point Discrete Fourier Transform (DFT) module 402 to transmit an uplink signal in SC-FDMA. The N-point DFT module 402 partially compensates for the effects of IDFT performed by the M-point IDFT module 404 so that a transmitted uplink signal has a single carrier property.

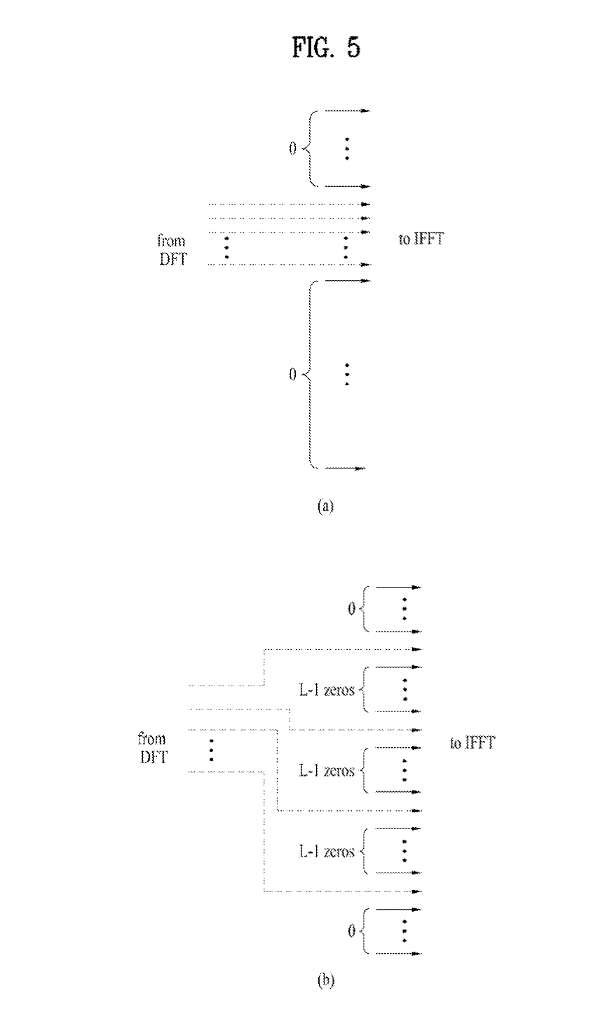

SC-FDMA should satisfy the single carrier property. FIG. 5 illustrates examples of mapping input symbols to subcarriers in the frequency domain in a manner that satisfies the single carrier property. A transmission signal satisfying the single carrier property can be achieved by allocating DFT symbols to subcarriers according to one of the schemes illustrated in FIGS. 5(a) and 5(b). Specifically, FIG. 5(a) illustrates localized mapping and FIG. 5(b) illustrates distributed mapping.

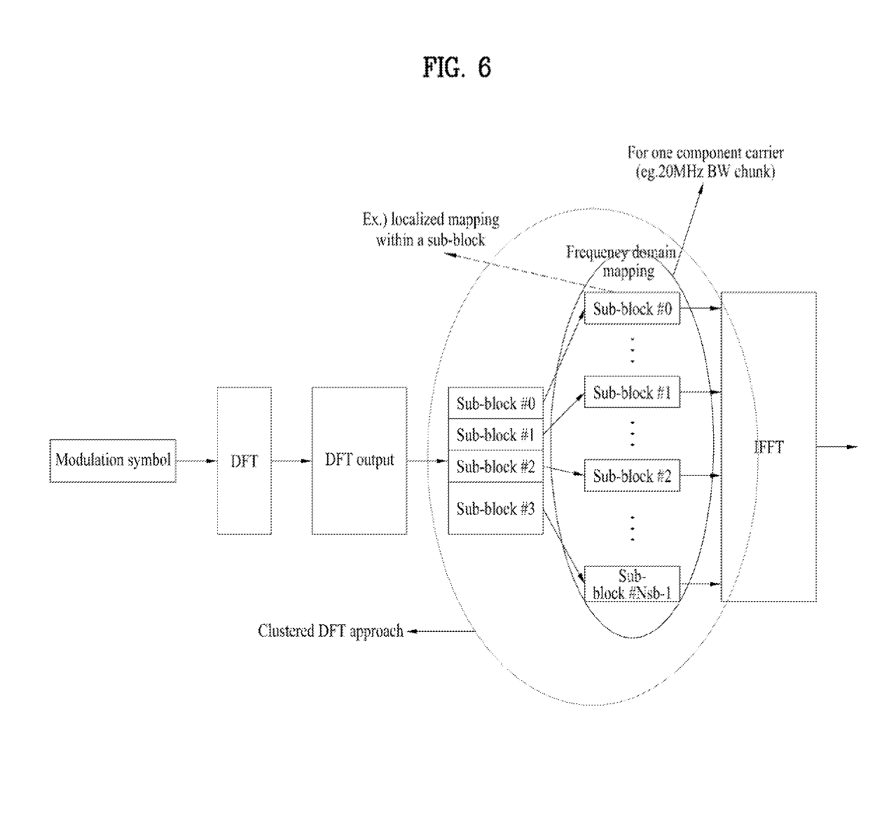

Meanwhile, the transmitters 100a and 100b may adopt clustered DFT spread OFDM (DFT-s-OFDM). Clustered DFT-s-OFDM is a modification of conventional SC-FDMA, in which a precoded signal is divided into a predetermined number of sub-blocks and mapped to non-contiguous subcarriers. FIGS. 6, 7 and 8 illustrate examples of mapping input symbols to a single carrier in clustered DFT-s-OFDM.

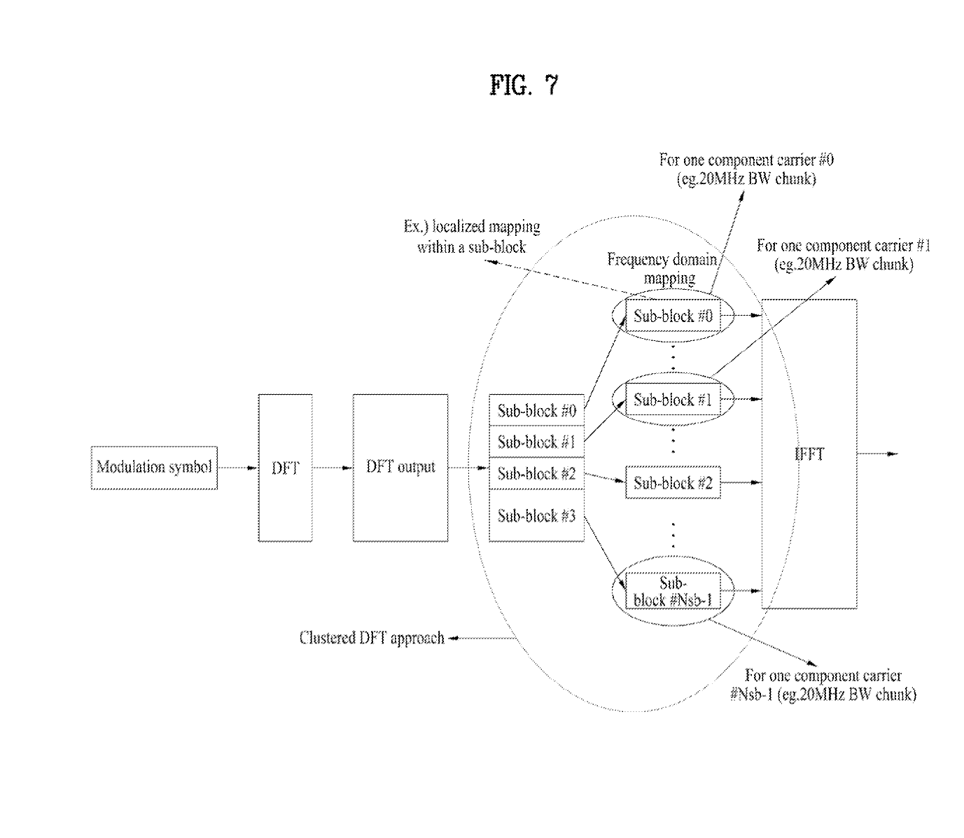

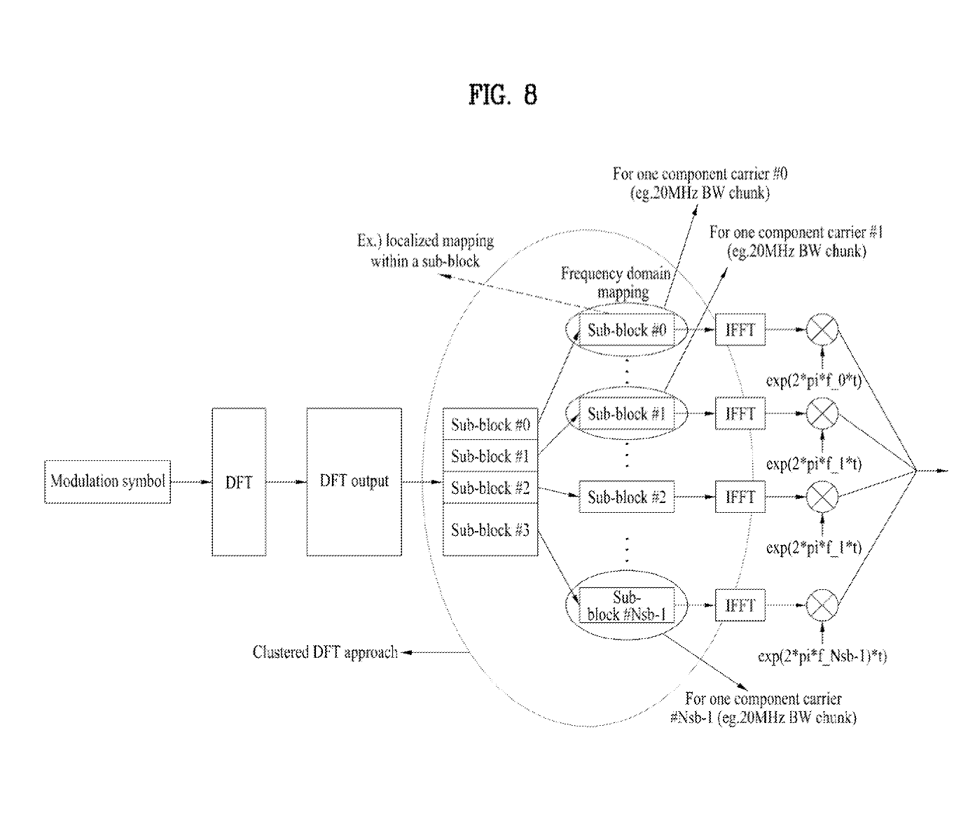

FIG. 6 illustrates an operation for mapping DFT output samples to a single carrier in clustered SC-FDMA. FIGS. 7 and 8 illustrate operations for mapping DFT output samples to multiple carriers in clustered SC-FDMA. FIG. 6 illustrates an example of applying intra-carrier clustered SC-FDMA, whereas FIGS. 7 and 8 illustrate examples of applying inter-carrier clustered SC-FDMA. More specifically, in a state in which contiguous component carriers (CCs) are allocated in the frequency domain, with their subcarriers aligned with a subcarrier spacing, a signal is generated in a single IFFT block in the illustrated case of FIG. 7. With non-contiguous CCs allocated in the frequency domain, a signal is generated in a plurality of IFFT blocks in the illustrated case of FIG. 8.

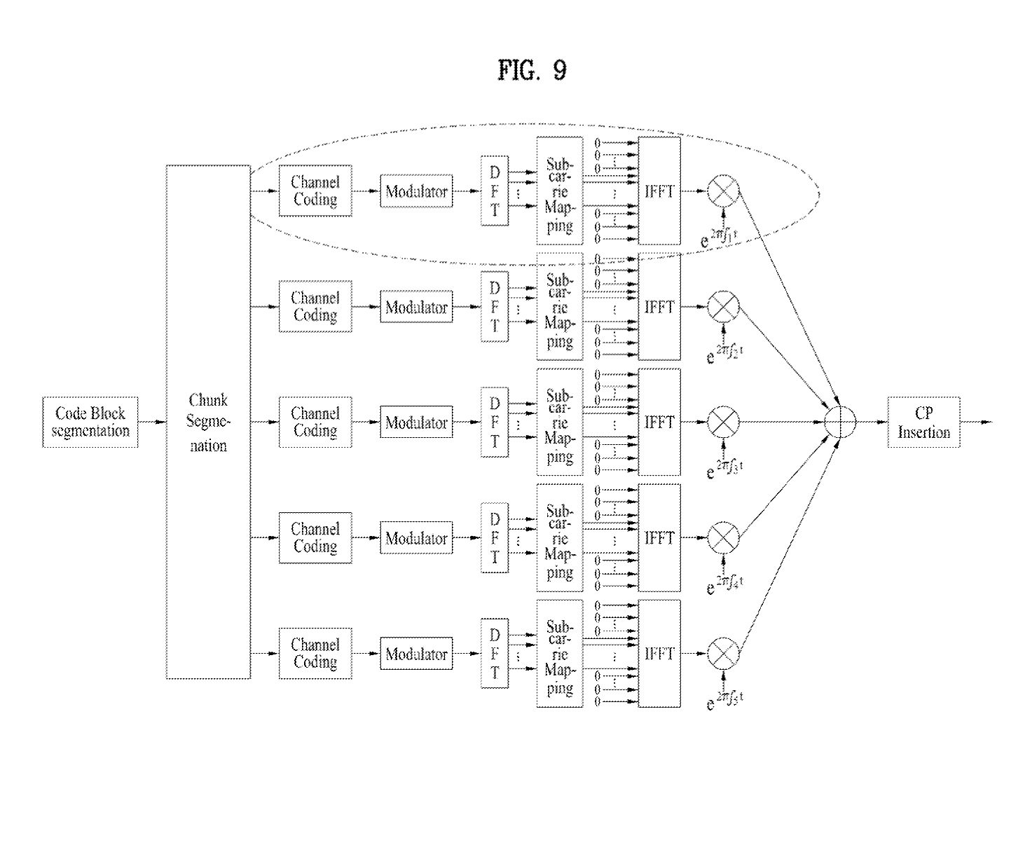

FIG. 9 illustrates a signal processing operation in segmented SC-FDMA.

As the number of DFT blocks is equal to the number of IFFT blocks and thus the DFT blocks and the IFFT blocks are in a one-to-one correspondence, segmented SC-FDMA is a simple extension of the DFT spreading and IFFT subcarrier mapping structure of the conventional SC-FDMA. Segmented SC-FDMA may also be called NxSC-FDMA or NxDFT-s-OFDMA. Herein, segmented SC-FDMA covers all these terms. Referring to FIG. 9, segmented SC-FDMA is characterized in that total time-domain modulation symbols are divided into N groups (N is an integer larger than 1) and a DFT process is performed on a group-by-group basis in order to relieve the single carrier property constraint.

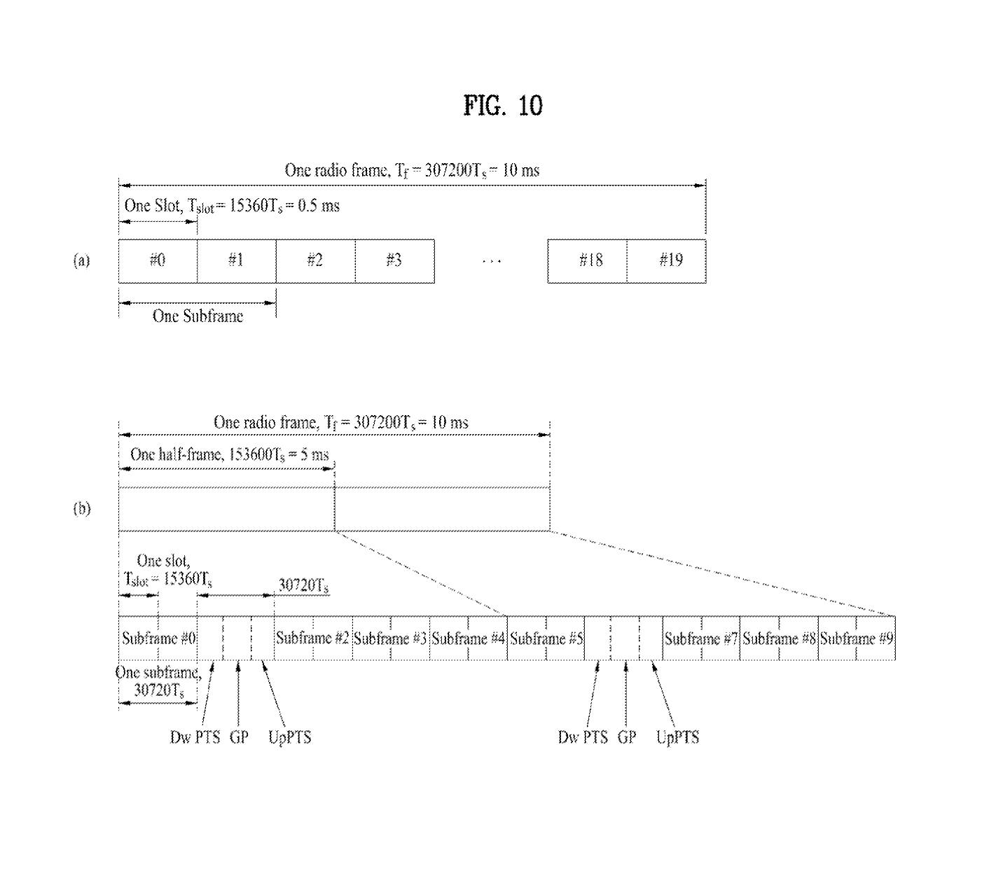

FIG. 10 illustrates exemplary radio frame structures used in a wireless communication system. Specifically, FIG. 10(a) illustrates a radio frame of Frame Structure 1 (FS-1) in the 3GPP LTE/LTE-A system and FIG. 10(b) illustrates a radio frame of Frame Structure 2 (FS-2) in the 3GPP LTE/LTE-A system. The frame structure of FIG. 10(a) may apply to Frequency Division Duplex (FDD) mode and half-FDD (H-FDD) mode, while the frame structure of FIG. 10(b) may apply to Time Division Duplex (TDD) mode.

Referring to FIG. 10, a radio frame is 10 ms (307200Ts) long in 3GPP LTE/LTE-A, including 10 equally sized subframes. The 10 subframes of the radio frame may be numbered. Herein, Tₛ is a sampling time, expressed as Tₛ=1/(2048×15 kHz). Each subframe is 1 ms long, including two slots. The 20 slots of the radio frame may be sequentially numbered from 0 to 19. Each slot has a length of 0.5 ms. A time required to transmit one subframe is defined as a Transmission Time Interval (TTI). Time resources may be identified by a radio frame number (or a radio frame index), a subframe number (or a subframe index), and a slot number (or a slot index).

Different radio frames may be configured for different duplex modes. For example, downlink transmission is distinguished from uplink transmission by frequency in the FDD mode. Therefore, a radio frame includes only downlink subframes or only uplink subframes.

On the other hand, since downlink transmission is distinguished from uplink transmission by time in the TDD mode, the subframes of a radio frame are divided into downlink subframes and uplink subframes.

FIG. 11 illustrates an uplink subframe structure to which the present invention is applied. Referring to FIG. 11, an uplink subframe may be divided into a control region and a data region in the frequency domain. At least one PUCCH may be allocated to the control region to transmit uplink control information (UCI). In addition, at least one PUSCH may be allocated to the data region to transmit user data. If a UE adopts SC-FDMA in LTE release 8 or release 9, it cannot transmit a PUCCH and a PUSCH simultaneously in order to maintain the single carrier property.

UCI transmitted on a PUCCH differs in size and usage depending on PUCCH formats. The size of UCI may also vary according to coding rate. For example, the following PUCCH formats may be defined.

(1) PUCCH Format 1: used for On-Off keying (OOK) modulation and Scheduling Request (SR).

(2) PUCCH Formats 1a and 1b: used for transmission of ACK/NACK information.

1) PUCCH Format 1a: 1-bit ACK/NACK information modulated in BPSK

2) PUCCH Format 1b: 2-bit ACK/NACK information modulated in QPSK

(3) PUCCH Format 2: modulated in QPSK and used for Channel Quality Indicator (CQI) transmission.

(4) PUCCH Formats 2a and 2b: used for simultaneous transmission of a CQI and ACK/NACK information.

Table 1 lists modulation schemes and numbers of bits per subframe for PUCCH formats and Table 2 lists numbers of Reference Signals (RSs) per slot for PUCCH formats. Table 3 lists SC-FDMA symbol positions of RSs for PUCCH formats. In Table 1, PUCCH Formats 2a and 2b are for the case of a normal CP.

TABLE 1

| | | Number of Bits |
|---|---|---|
| PUCCH Format | Modulation | per Subframe |
| 1 | N/A | N/A |
| 1a | BPSK | 1 |
| 1b | QPSK | 2 |
| 2 | QPSK | 20 |
| 2a | QPSK + BPSK | 21 |
| 2b | QPSK + BPSK | 22 |

TABLE 2

| PUCCH Format | Normal CP | Extended CP |
|---|---|---|
| 1, 1a, 1b | 3 | 2 |
| 2 | 2 | 1 |
| 2a, 2b | 2 | N/A |

TABLE 3

SC-FDMA Symbol Position of RS

| PUCCH Format | Normal CP | Extended CP |
|---|---|---|
| 1, 1a, 1b | 2, 3, 4 | 2, 3 |
| 2, 2a, 2b | 1, 5 | 3 |

Subcarriers far from a DC (Direct Current) subcarrier are used for the control region in the uplink subframe. In other words, subcarriers at both ends of an uplink transmission bandwidth are allocated for transmission of UCI. The DC subcarrier is a component that is spared from signal transmission and mapped to carrier frequency f₀ during frequency upconversion performed by an OFDMA/SC-FDMA signal generator.

A PUCCH from one UE is allocated to an RB pair in a subframe and the RBs of the RB pair occupy different subcarriers in two slots. This PUCCH allocation is called frequency hopping of an RB pair allocated to a PUCCH over a slot boundary. However, if frequency hopping is not applied, the RB pair occupies the same subcarriers in two slots. Since a PUCCH from a UE is allocated to an RB pair in a subframe irrespective of frequency hopping, the same PUCCH is transmitted twice, each time in one RB of each slot in the subframe.

Hereinafter, an RB pair used for transmission of a PUCCH in a subframe is referred to as a PUCCH region. A PUCCH region and a code used therein are referred to as a PUCCH resource. That is, different PUCCH resources may have different PUCCH regions or may have different codes in the same PUCCH regions. For convenience, a PUCCH carrying ACK/NACK information is referred to as an ACK/NACK PUCCH, a PUCCH carrying Channel Quality Indicator/Precoding Matrix Index/Rank Indicator (CQI/PMI/RI) information is referred to as a Channel State Information (CSI) PUCCH, and a PUCCH carrying SR information is referred to as an SR PUCCH.

A BS allocates PUCCH resources to a UE explicitly or implicitly, for transmission of UCI.

UCI such as ACK/NACK information, CQI information, PMI information, RI information, and SR information may be transmitted in the control region of an uplink subframe.

The UE and the BS transmit and receive signals or data from or to each other in the wireless communication system. When the BS transmits data to the UE, the UE decodes the received data. If data decoding is successful, the UE transmits an ACK to the BS. On the contrary, if data decoding fails, the UE transmits a NACK to the BS. The same applies to the opposite case, that is, the case where the UE transmits data to the BS. In the 3GPP LTE system, the UE receives a PDSCH from the BS and transmits an ACK/NACK for the received PDSCH on a PUCCH that is implicitly determined by a PDCCH carrying scheduling information for the PDSCH. A state in which the UE does not receive data may be regarded as a discontinuous transmission (DTX) state. In this case, the state may be processed as a case in which there is no received data according to a predetermined rule or a NACK case (in which decoding of data is not successful although the data is received).

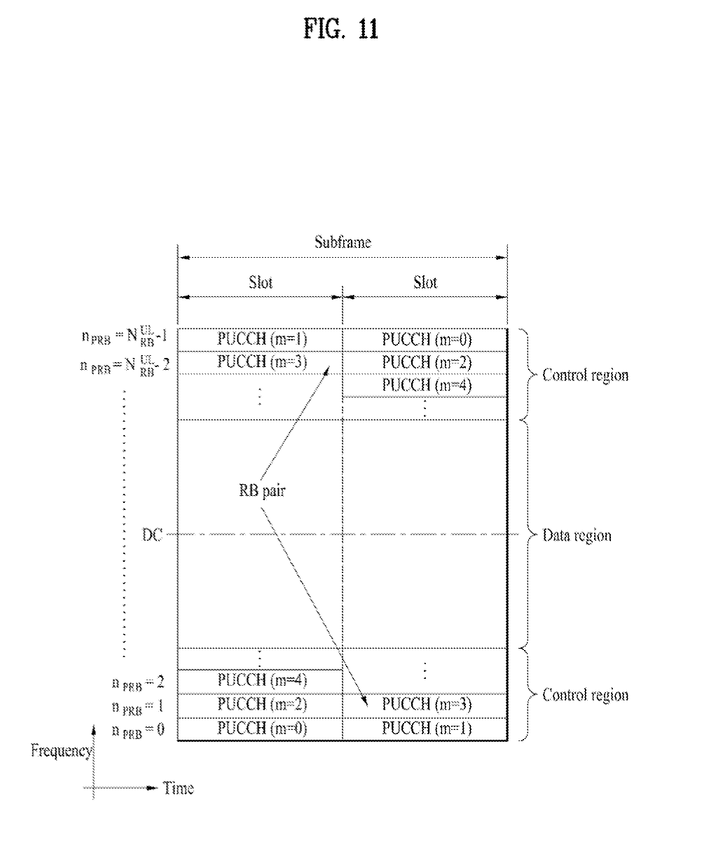

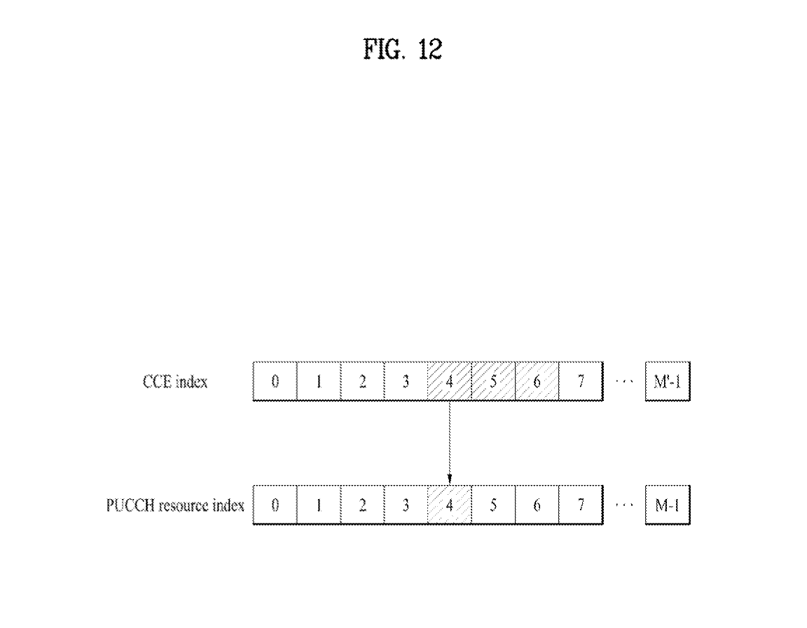

FIG. 12 illustrates a structure for determining a PUCCH for ACK/NACK transmission, to which the present invention is applied.

A PUCCH that will carry ACK/NACK information is not allocated to a UE in advance. Rather, a plurality of PUCCHs are used separately at each time instant by a plurality of UEs within a cell. Specifically, a PUCCH that a UE will use to transmit ACK/NACK information is implicitly determined on the basis of a PDCCH carrying scheduling information for a PDSCH that delivers downlink data. An entire area carrying PDCCHs in a downlink subframe includes a plurality of Control Channel Elements (CCEs) and a PDCCH transmitted to a UE includes one or more CCEs. A CCE includes a plurality of (e.g. 9) Resource Element Groups (REGs). One REG includes four contiguous REs except for an RS. The UE transmits ACK/NACK information on an implicit PUCCH that is derived or calculated by a function of a specific CCE index (e.g. the first or lowest CCE index) from among the indexes of CCEs included in a received PDCCH.

Referring to FIG. 12, PUCCH resource indexes indicate PUCCHs for transmitting an ACK/NACK. As illustrated in FIG. 12, on the assumption that a PDCCH including CCEs #4, #5 and #6 delivers scheduling information for a PDSCH to a UE, the UE transmits an ACK/NACK to a BS on a PUCCH, for example, PUCCH #4 derived or calculated using the lowest CCE index of the PDCCH, CCE index 4.

In the illustrated case of FIG. 12, there are up to M′ CCEs in a downlink subframe and up to M PUCCHs in an uplink subframe. Although M may be equal to M′, M may be different from M′ and CCEs may be mapped to PUCCHs in an overlapping manner. For instance, a PUCCH resource index may be calculated by the following equation.

n⁽¹⁾_{PUCCH}=n_{CCE}+N⁽¹⁾_{PUCCH} [Equation 1]

Here, n⁽¹⁾_{PUCCH} denotes the index of a PUCCH resource for transmitting ACK/NACK information, N⁽¹⁾_{PUCCH} denotes a signal value received from a higher layer, and n_{CCE} denotes the lowest of CCE indexes used for transmission of a PDCCH.

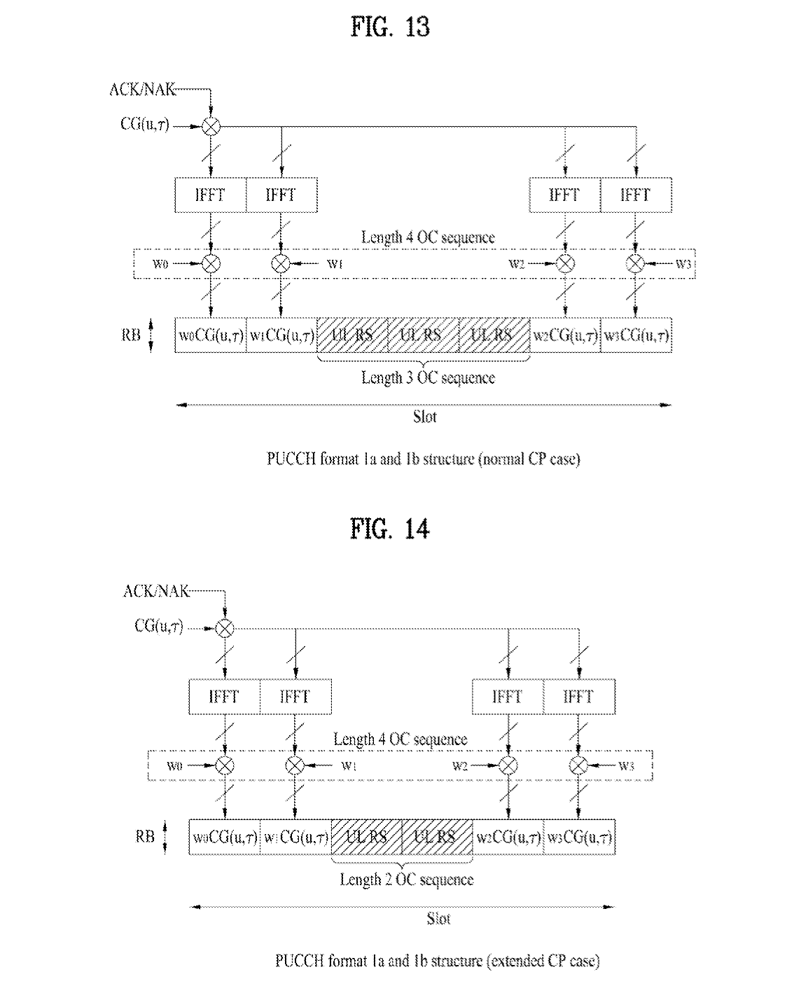

FIGS. 13 and 14 illustrate slot-level structures of PUCCH Formats 1a and 1b for ACK/NACK transmission.

FIG. 13 illustrates PUCCH Formats 1a and 1b in case of a normal CP and FIG. 14 illustrates PUCCH Formats 1a and 1b in case of an extended CP. The same UCI is repeated on a slot basis in a subframe in PUCCH Format 1a and 1b. A UE transmits an ACK/NACK signal in the resources of a different Cyclic Shift (CS) (a frequency-domain code) of a Computer-Generated Constant Amplitude Zero Auto Correlation (CG-CAZAC) sequence and an Orthogonal Cover (OC) or Orthogonal Cover Code (OCC) (a time-domain spreading code). The OC includes, for example, a Walsh/DFT orthogonal code. Given six CSs and three OCs, a total of 18 UEs may be multiplexed into the same PRB, for a single antenna. An OC sequence w0, w1, w2 and w3 is applicable to a time domain (after FFT modulation) or to a frequency domain (before FFT modulation). PUCCH Format 1 for transmitting SR information is the same as PUCCH Formats 1a and 1b in terms of slot-level structure and different from PUCCH Formats 1a and 1b in terms of modulation.

PUCCH resources composed of a CS, an OC, and a physical resource block (PRB) may be allocated to a UE by Radio Resource Control (RRC) signaling, for transmission of SR information and an ACK/NACK for Semi-Persistent Scheduling (SPS). As described before with reference to FIG. 12, PUCCH resources may be indicated to a UE implicitly using the lowest CCE index of a PDCCH corresponding to a PDSCH or the lowest CCE index of a PDCCH for SPS release, for dynamic ACK/NACK (or an ACK/NACK for non-persistent scheduling) feedback or ACK/NACK feedback for a PDCCH indicating SPS release.

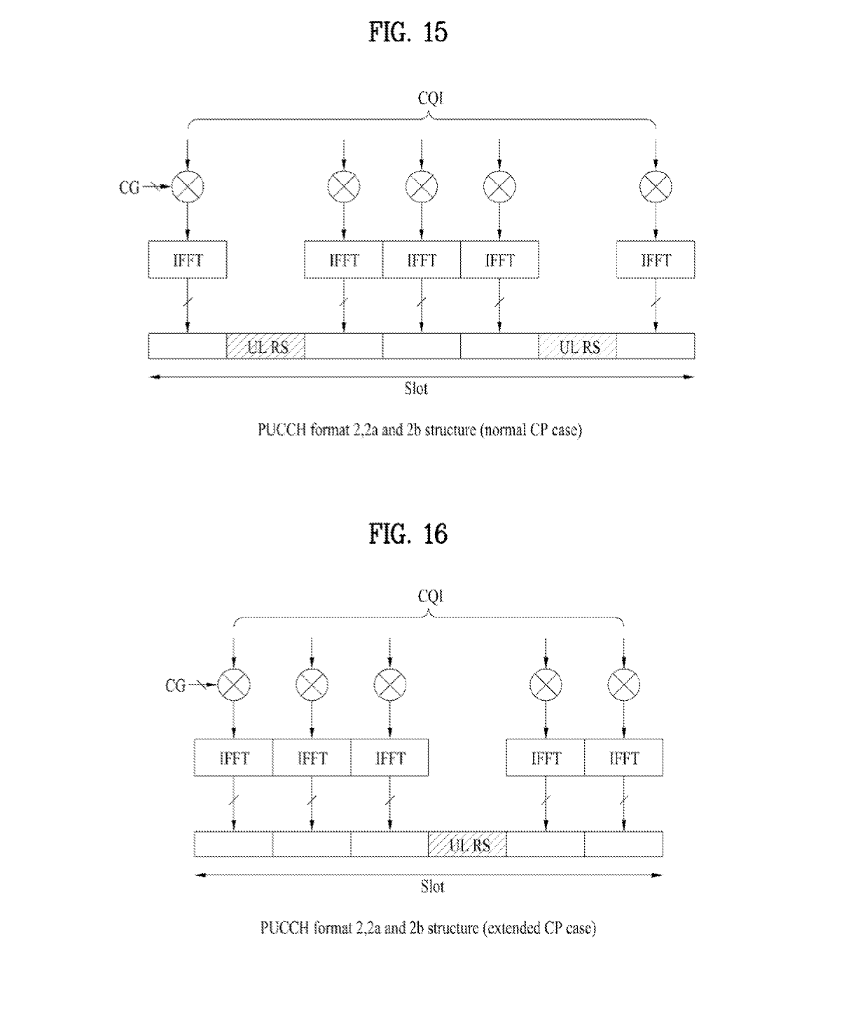

FIG. 15 illustrates PUCCH Format 2/2a/2b in case of a normal CP and FIG. 16 illustrates PUCCH Format 2/2a/2b in case of an extended CP. Referring to FIGS. 15 and 16, one subframe includes 10 QPSK symbols except for an RS symbol in case of a normal CP. Each QPSK symbol is spread with a CS in the frequency domain and then mapped to a corresponding SC-FDMA symbol. SC-FDMA symbol-level CS hopping may be used to randomize inter-cell interference. An RS may be Code Division Multiplexed (CDM) using a CS. For example, if there are 12 or 6 available CSs, 12 or 6 UEs may be multiplexed in the same PRB. That is, a plurality of UEs may be multiplexed using CS+OC+PRB and CS+PRB in PUCCH Formats 1/1a/1b and 2/2a/2b.

OCs of length 4 or length 3 for PUCCH Format 1/1a/1b are illustrated in Table 4 and Table 5 below.

TABLE 4

| Sequence Index | OC |
|---|---|
| 0 | [+1 +1 +1 +1] |
| 1 | [+1 −1 +1 −1] |
| 2 | [+1 −1 −1 +1] |

TABLE 5

| Sequence Index | OC |
|---|---|
| 0 | [1 1 1] |
| 1 | [1 e^{j2π/3} e^{j4π/3}] |
| 2 | [1 e^{j4π/3} e^{j2π/3}] |

OCs for RSs in PUCCH Format 1/1a/1b are given in Table 6 below.

TABLE 6

| Sequence Index | Normal CP | Extended CP |
|---|---|---|
| 0 | [1 1 1] | [1 1] |
| 1 | [1 e^{j2π/3} e^{j4π/3}] | [1 −1] |
| 2 | [1 e^{j4π/3} e^{j2π/3}] | N/A |

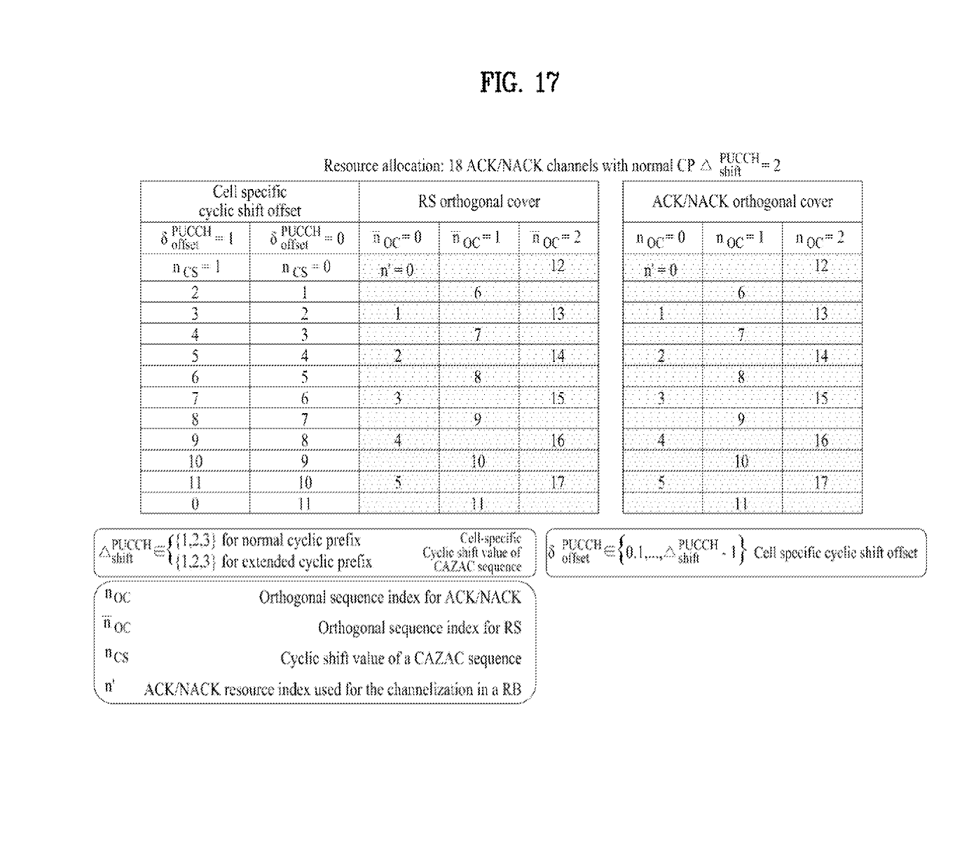

FIG. 17 illustrates ACK/NACK channelization for PUCCH Formats 1a and 1b. In FIG. 14, Δ_{shift}^{PUCCH}=2.

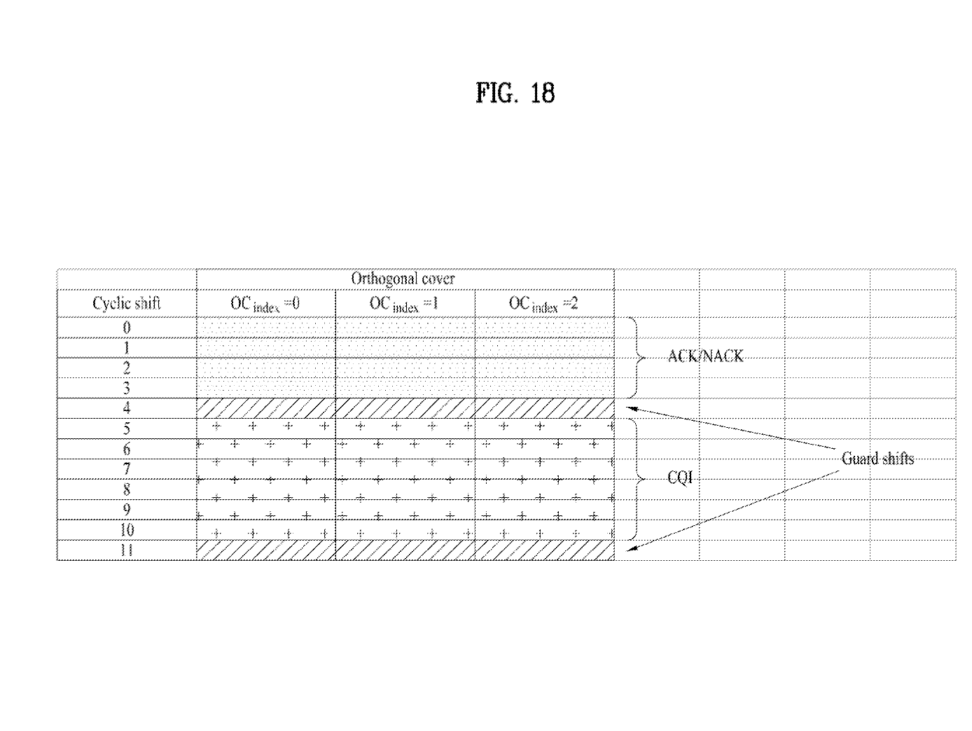

FIG. 18 illustrates channelization for a hybrid structure of PUCCH Format 1/1a/1b and PUCCH Format 2/2a/2b in the same PRB.

CS hopping and OC re-mapping may be performed as follows.

(1) Symbol-based cell-specific CS hopping to randomize inter-cell interference

(2) Slot-level CS/OS re-mapping

1) for randomization of inter-cell interference

2) slot-based approach for mapping between ACK/NACK channels and resources k Meanwhile, resources nᵣ for PUCCH Format 1/1a/1b include the following combinations.

(1) CS (identical to DFT OC at symbol level) (n_{cs})

(2) OC (OC at slot level) (n_{oc})

(3) Frequency RB (n_{rb})

Let the indexes of a CS, an OC, and an RB be denoted by n_{cs}, n_{oc}, and n_{rb}, respectively. Then, a representative index nᵣ includes n_{cs}, n_{oc}, and n_{rb}. nᵣ satisfies nᵣ=(n_{cs}, n_{oc}, n_{rb}).

A combination of an ACK/NACK and a CQI, PMI, RI and CQI may be delivered in PUCCH Format 2/2a/2b. Reed Muller (RM) channel coding may be applied.

For example, channel coding for an uplink CQI is described as follows in the LTE system. A bit stream α₀, α₁, α₂, α₃, . . . , α_{A-1} is channel-encoded with a (20, A) RM code. Table 7 lists base sequences for the (20, A) code. α₀ and α_{A-1} are the Most Significant Bit (MS) and Least Significant Bit (LSB), respectively. Aside from simultaneous transmission of a CQI and an ACK/NACK, up to 11 bits can be transmitted in case of an extended CP. A bit stream may be encoded to 20 bits by an RM code and then modulated in QPSK. Before QPSK modulation, the coded bits may be scrambled.

TABLE 7

| I | M_{i,0} | M_{i,1} | M_{i,2} | M_{i,3} | M_{i,4} | M_{i,5} | M_{i,6} | M_{i,7} | M_{i,8} | M_{i,9} | M_{i,10} | M_{i,11} | M_{i,12} |
|---|---|---|---|---|---|---|---|---|---|---|---|---|---|
| 0 | 1 | 1 | 0 | 0 | 0 | 0 | 0 | 0 | 0 | 0 | 1 | 1 | 0 |
| 1 | 1 | 1 | 1 | 0 | 0 | 0 | 0 | 0 | 0 | 1 | 1 | 1 | 0 |
| 2 | 1 | 0 | 0 | 1 | 0 | 0 | 1 | 0 | 1 | 1 | 1 | 1 | 1 |
| 3 | 1 | 0 | 1 | 1 | 0 | 0 | 0 | 0 | 1 | 0 | 1 | 1 | 1 |
| 4 | 1 | 1 | 1 | 1 | 0 | 0 | 0 | 1 | 0 | 0 | 1 | 1 | 1 |
| 5 | 1 | 1 | 0 | 0 | 1 | 0 | 1 | 1 | 1 | 0 | 1 | 1 | 1 |
| 6 | 1 | 0 | 1 | 0 | 1 | 0 | 1 | 0 | 1 | 1 | 1 | 1 | 1 |
| 7 | 1 | 0 | 0 | 1 | 1 | 0 | 0 | 1 | 1 | 0 | 1 | 1 | 1 |
| 8 | 1 | 1 | 0 | 1 | 1 | 0 | 0 | 1 | 0 | 1 | 1 | 1 | 1 |
| 9 | 1 | 0 | 1 | 1 | 1 | 0 | 1 | 0 | 0 | 1 | 1 | 1 | 1 |
| 10 | 1 | 0 | 1 | 0 | 0 | 1 | 1 | 1 | 0 | 1 | 1 | 1 | 1 |
| 11 | 1 | 1 | 1 | 0 | 0 | 1 | 1 | 0 | 1 | 0 | 1 | 1 | 1 |
| 12 | 1 | 0 | 0 | 1 | 0 | 1 | 0 | 1 | 1 | 1 | 1 | 1 | 1 |
| 13 | 1 | 1 | 0 | 1 | 0 | 1 | 0 | 1 | 0 | 1 | 1 | 1 | 1 |
| 14 | 1 | 0 | 0 | 0 | 1 | 1 | 0 | 1 | 0 | 0 | 1 | 0 | 1 |
| 15 | 1 | 1 | 0 | 0 | 1 | 1 | 1 | 1 | 0 | 1 | 1 | 0 | 1 |
| 16 | 1 | 1 | 1 | 0 | 1 | 1 | 1 | 0 | 0 | 1 | 0 | 1 | 1 |
| 17 | 1 | 0 | 0 | 1 | 1 | 1 | 0 | 0 | 1 | 0 | 0 | 1 | 1 |
| 18 | 1 | 1 | 0 | 1 | 1 | 1 | 1 | 1 | 0 | 0 | 0 | 0 | 0 |
| 19 | 1 | 0 | 0 | 0 | 0 | 1 | 1 | 0 | 0 | 0 | 0 | 0 | 0 |

Channel-coded bits b₀, b₁, b₂, b₃, . . . , b_{B-1} may be generated by Equation 2.

$${b}_{i} = {\sum }_{n = 0}^{A - 1} ( {a}_{n} \cdot {M}_{i , n} ) mod 2 \qquad [ Equation 2 ]$$

Here, i=0, 1, 2, . . . , B−1.

Table 8 illustrates a UCI field for feedback of a broadband report (a single antenna port, transmit diversity, or open loop spatial multiplexing PDSCH) CQI.

TABLE 8

| Field | Bandwidth |
|---|---|
| Broadband CQI | 4 |

Table 9 illustrates a UCI field for feedback of a broadband CQI and a PMI. This field reports transmission of a closed loop spatial multiplexing PDSCH.

TABLE 9

| | Bandwidth | | | |
|---|---|---|---|---|
| | 2 antenna ports | | 4 antenna ports | |
| Field | Rank = 1 | Rank = 2 | Rank = 1 | Rank > 1 |
| Broadband CQI | 4 | 4 | 4 | 4 |
| Spatial-domain | 0 | 3 | 0 | 3 |
| differential CQI | | | | |
| PMI | 2 | 1 | 4 | 4 |

Table 10 illustrates a UCI field to feedback an RI for a broadband report.

TABLE 10

Bit widths

4 antenna ports

| Field | 2 antenna ports | Up to 2 layers | Up to 4 layers |
|---|---|---|---|
| RI (Rank | 1 | 1 | 2 |
| Indication) | | | |

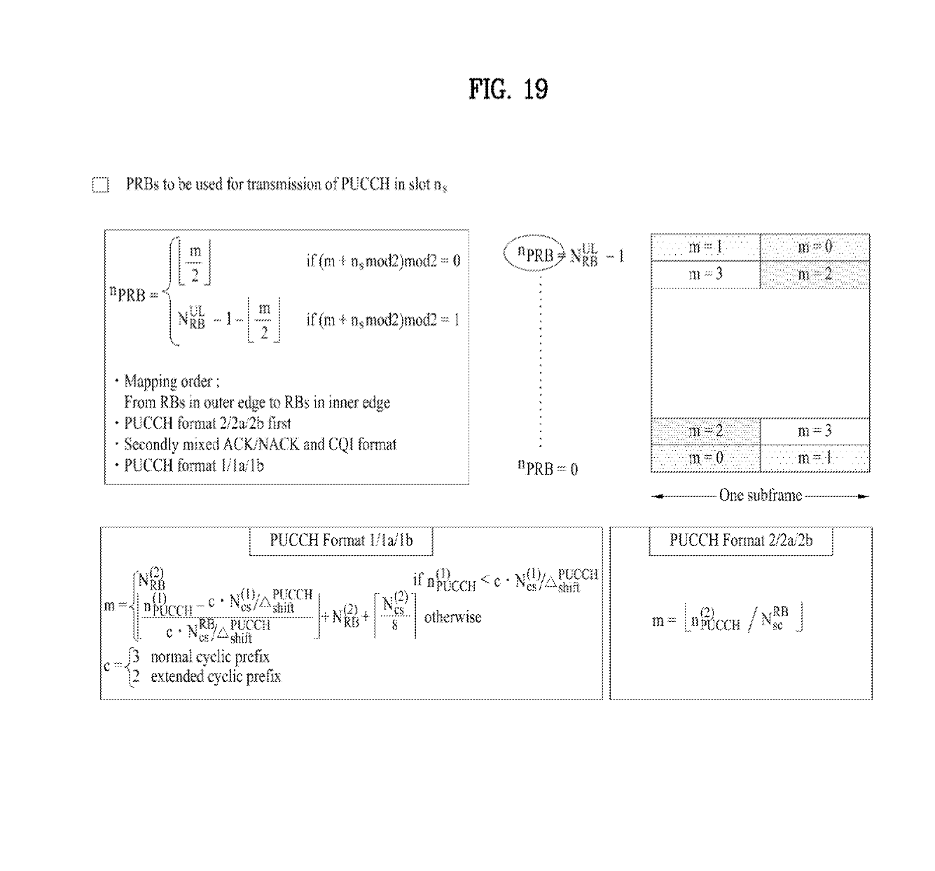

FIG. 19 illustrates PRB allocation. Referring to FIG. 19, a PRB may be used to carry a PUCCH in slot nₛ.

A multi-carrier system or Carrier Aggregation (CA) system is a system using a plurality of carriers each having a narrower bandwidth than a target bandwidth in order to support broadband. When a plurality of carriers each having a narrower bandwidth than a target band are aggregated, the bandwidth of each of the aggregated carriers may be limited to a bandwidth used in a legacy system in order to ensure backward compatibility with the legacy system. For example, the legacy LTE system supports 1.4, 3, 5, 10, 15, and 20 MHz and the LTE-A system evolved from the LTE system may support a broader bandwidth than 20 MHz using only bandwidths supported by the LTE system. Alternatively, CA may be supported by defining a new bandwidth irrespective of the bandwidths used in the legacy system. The term multi-carrier is used interchangeably with CA and spectrum aggregation. In addition, CA covers both contiguous CA and non-contiguous CA. Furthermore, CA my cover both intra-band CA and inter-band CA.

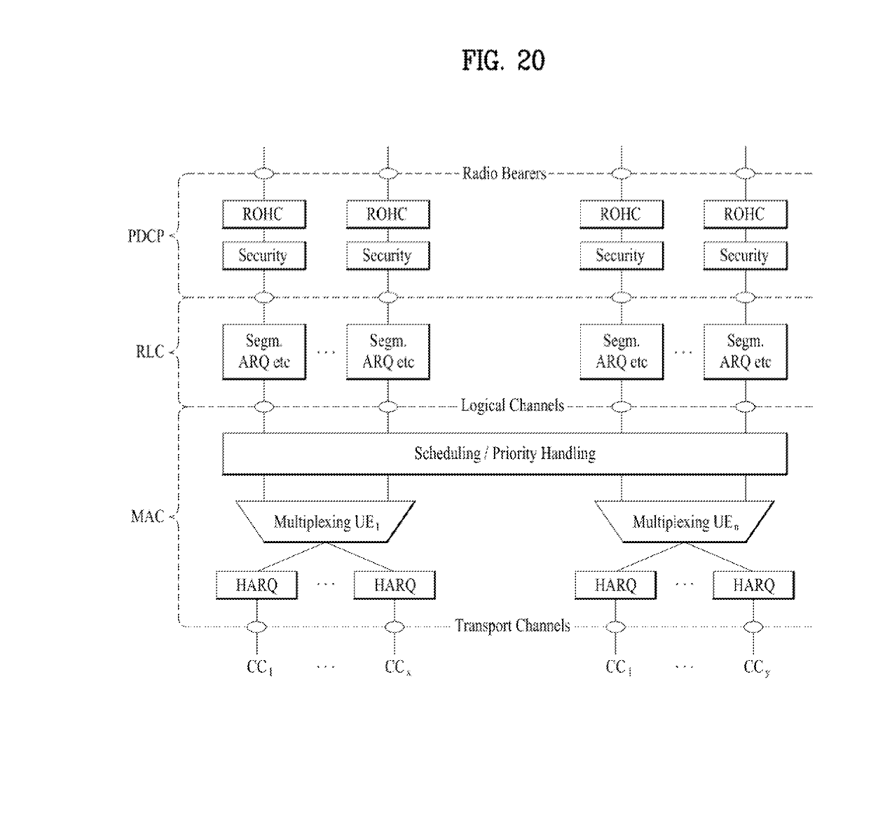

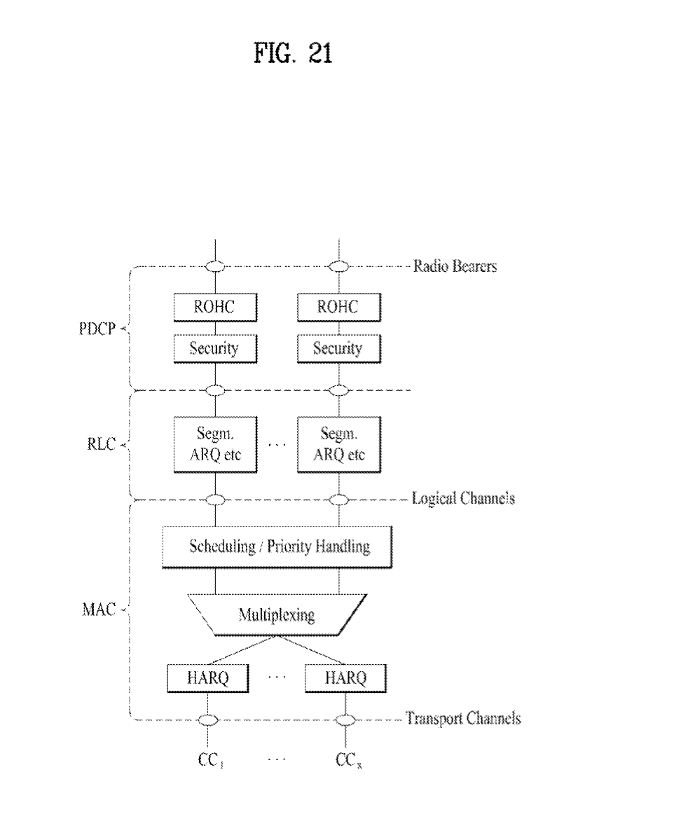

FIG. 20 is a conceptual view illustrating DL CC management at a BS and FIG. 21 illustrates a conceptual view illustrating UL CC management at a UE. For convenience, a higher layer will be referred simply as a MAC layer in FIGS. 19 and 20.

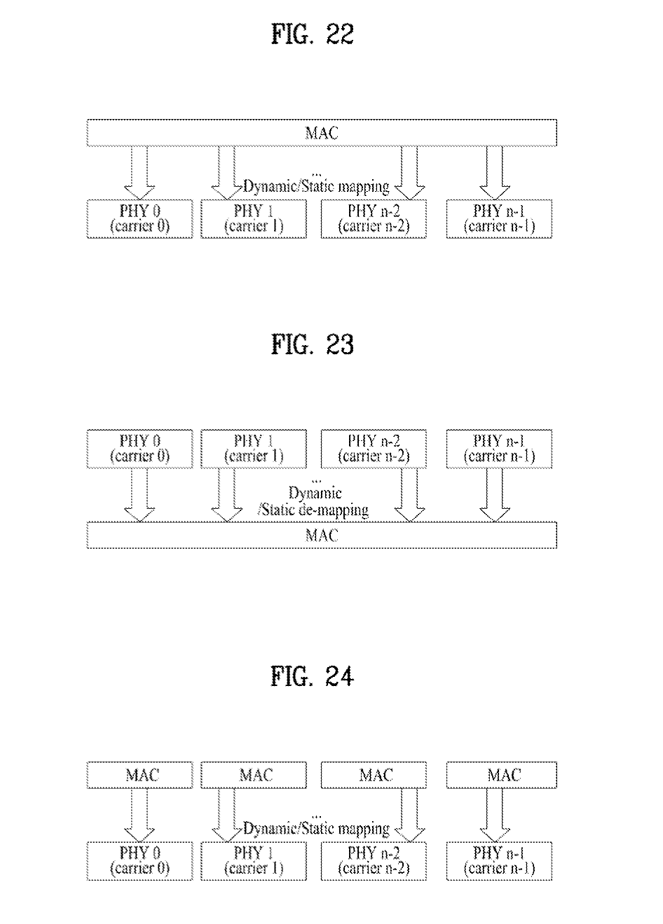

FIG. 22 is a conceptual view illustrating multi-carrier management of one MAC layer at a BS and FIG. 23 is a conceptual view illustrating multi-carrier management of one MAC layer at a UE.

Referring to FIGS. 22 and 23, one MAC layer performs transmission and reception by managing and operating one or more frequency carriers. Because the frequency carriers managed by the single MAC layer do not need to be contiguous, this multi-carrier management scheme is more flexible in terms of resource management. In FIGS. 22 and 23, one PHYsical (PHY) layer refers to one CC, for convenience. Yet, a PHY layer is not necessarily an independent Radio Frequency (RF) device. While one independent RF device generally corresponds to one PHY layer, it may include a plurality of PHY layers.

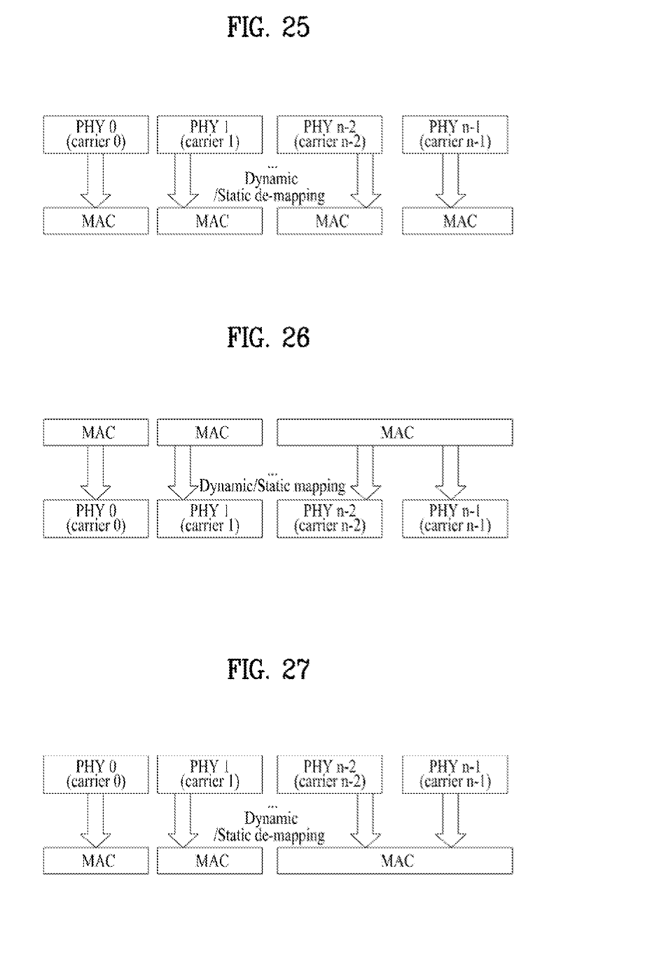

FIG. 24 is a conceptual view illustrating multi-carrier management of a plurality of MAC layers at a BS, FIG. 25 is a conceptual view illustrating multi-carrier management of a plurality of MAC layers at a UE, FIG. 26 is another conceptual view illustrating multi-carrier management of a plurality of MAC layers at a BS, and FIG. 27 is another conceptual view illustrating multi-carrier management of a plurality of MAC layers at a UE.

Apart from the structures illustrated in FIGS. 22 and 23, a plurality of MAC layers may control a plurality of carriers, as illustrated in FIGS. 24 to 27.

Each MAC layer may control one carrier in a one-to-one correspondence as illustrated in FIGS. 24 and 25, whereas each MAC layer may control one carrier in a one-to-one correspondence, for some carriers and one MAC layer may control one or more of the remaining carriers as illustrated in FIGS. 26 and 27.

The above-described system uses a plurality of carriers, that is, first to N^{th} carriers, and the carriers may be contiguous or non-contiguous irrespective of downlink or uplink. A TDD system is configured to use N carriers such that downlink transmission and uplink transmission take place on each carrier, whereas an FDD system is configured to use a plurality of carriers for each of downlink transmission and uplink transmission. The FDD system may support asymmetrical CA in which different numbers of carriers and/or carriers having different bandwidths are aggregated for downlink and uplink.

When the same number of CCs is aggregated for downlink and uplink, all CCs can be configured with backward compatibility with the legacy system. However, CCs without backward compatibility are not excluded from the present invention.

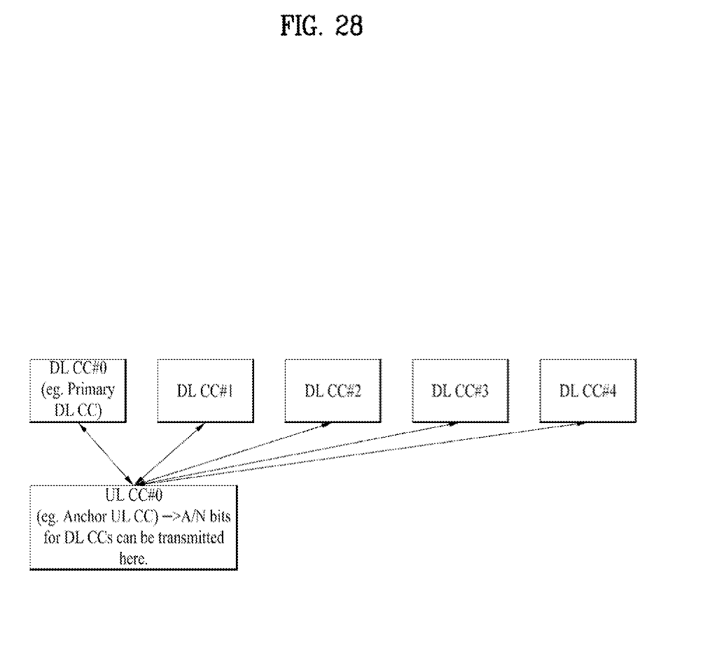

FIG. 28 illustrates exemplary asymmetrical CA in which five DL CCs are linked to a single UL CC. This asymmetrical CA may be set from the perspective of transmitting UCI. Specific UCI (e.g. ACK/NACK responses) for a plurality of DL CCs are aggregated in a single UL CC and transmitted. When a plurality of UL CCs is configured, specific UCI (e.g. ACKs/NACKs for DL CCs) are transmitted on a predetermined UL CC (e.g., primary CC, primary cell or PCell). For convenience, if it is assumed that each DL CC can carry up to two codewords and the number of ACKs/NACKs for each CC depends on the maximum number of codewords set per CC (for example, if a BS sets up to two codewords for a specific CC, even though a specific PDCCH uses only one codeword on the CC, two ACKs/NACKs are set for the CC), at least two UL ACK/NACK bits are needed for each DL CC. In this case, to transmit ACKs/NACKs for data received on five DL CCs on a single UL CC, at least ten ACK/NACK bits are needed. If a Discontinuous Transmission (DTX) state is also to be indicated for each DL CC, at least 12 bits (=5⁶=3125=11.61 bits) are required for ACK/NACK transmission. Since up to two ACK/NACK bits are available in the conventional PUCCH Formats 1a and 1b, this structure cannot transmit increased ACK/NACK information. While CA is given as an example of a cause to increase the amount of UCI, this situation may also occur due to an increase in the number of antennas and the existence of a backhaul subframe in a TDD system and a relay system. Like ACK/NACK transmission, the amount of control information to be transmitted is also increased when control information related to a plurality of DL CCs is to be transmitted on a single UL CC. For example, transmission of CQI/PMI/RI information related to a plurality of DL CCs may increase UCI payload. While ACK/NACK information related to codewords is described in the present invention by way of example, it is obviously to be understood that a transport block corresponding to a codeword exists and the same is applicable to ACK/NACK information for transport blocks. Furthermore, while ACK/NACK information for a DL subframe per DL CC for transmission on one UL CC is described by way of example, it is obvious that ACK/NACK information for one or more DL subframes per DL CC for transmission on one UL CC is applicable when the present invention is applied to a TDD system.

In FIG. 28, a UL anchor CC (a UL PCC or a UL primary CC) is a CC that delivers a PUCCH or UCI, determined cell-specifically/UE-specifically. For example, a UE can determine a CC for which initial random access is attempted as the primary CC. A DTX state may be fed back explicitly or may be fed back so as to share the same state with a NACK.

In LTE-A, the concept of a cell is used to manage radio resources. A cell is defined as a combination of downlink resources and uplink resources. Yet, the uplink resources are not mandatory. Therefore, a cell may be composed of downlink resources only or both downlink resources and uplink resources. The linkage between the carrier frequencies (or DL CCs) of downlink resources and the carrier frequencies (or UL CCs) of uplink resources may be indicated by system information. A cell operating in primary frequency resources (or a PCC) may be referred to as a primary cell (PCell) and a cell operating in secondary frequency resources (or an SCC) may be referred to as a secondary cell (SCell). The PCell is used for a UE to establish an initial connection or re-establish a connection. The PCell may refer to a cell indicated during handover. Only one PCell can exist during CA in LTE-A release 10. The SCell may be configured after an RRC connection is established and may be used to provide additional radio resources. The PCell and the SCell may collectively be referred to as a serving cell. Accordingly, a single serving cell composed of a PCell only exists for a UE in RRC_Connected state, for which CA is not set or which does not support CA. On the other hand, one or more serving cells exist, including a PCell and entire SCells, for a UE in RRC_CONNECTED state, for which CA is set. For CA, a network may configure one or more SCells in addition to an initially configured PCell, for a UE supporting CA during connection setup after an initial security activation operation is initiated. Therefore, PCC is interchangeably used with PCell, primary (radio) resources, and primary frequency resources. Similarly, SCC is used interchangeably with SCell, secondary (radio) resources, and secondary frequency resources.

Now a description will be given of a method for efficiently transmitting increased UCI with reference to drawings. Specifically, a new PUCCH format, a signal processing operation, and a resource allocation method for transmitting increased UCI are proposed. The new PUCCH format proposed by the present invention is called CA PUCCH Format or PUCCH Format 3, considering that PUCCH Format 1 to PUCCH Format 2 are defined in legacy LTE Release 8/9. The technical features of the proposed PUCCH format may be applied to any physical channel (e.g. a PUSCH) that can deliver UCI in the same manner or in a similar manner. For example, an embodiment of the present invention is applicable to a periodic PUSCH structure for transmitting control information periodically or a non-periodic PUSCH structure for transmitting control information non-periodically.

The following drawings and embodiments of the present invention will be described focusing on a case in which the UCI/RS symbol structure of the legacy LTE PUCCH Format 1/1a/1b (in case of a normal CP) is used as a subframe-level/slot-level UCI/RS symbol structure applied to PUCCH Format 3. However, the subframe-level/slot-level UCI/RS symbol structure of PUCCH Format 3 is defined to provide an example, which should not be construed as limiting the present invention. The number and positions of UCI/RS symbols may be changed freely in PUCCH Format 3 of the present invention according to system design. For example, PUCCH Format 3 according to an embodiment of the present invention may be defined using the RS symbol structure of the legacy LTE PUCCH Format 2/2a/2b.

PUCCH Format 3 according to the embodiment of the present invention may be used to transmit UCI of any type or size. For example, information such as HARQ ACK/NACK, CQI, PMI, RI, and SR may be transmitted in PUCCH Format 3 according to the embodiment of the present invention. This information may have a payload of any size. For convenience, the following description will focus on transmission of ACK/NACK information in PUCCH Format 3 according to the present invention.

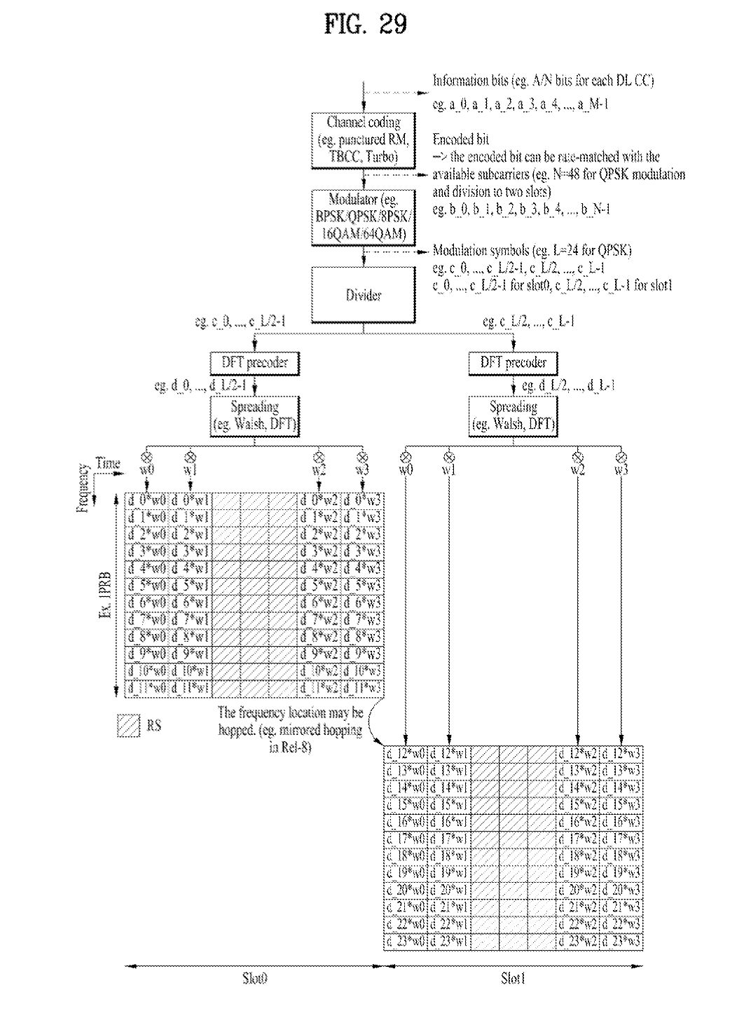

FIGS. 29 to 32 illustrate the structure of PUCCH Format 3 that can be used in the present invention and a signal processing operation for PUCCH Format 3. Especially, FIGS. 29 to 32 illustrate a DFT-based PUCCH format. According to the DFT-based PUCCH structure, a PUCCH is DFT-precoded and spread with a time-domain OC at an SC-FDMA level, prior to transmission. Hereinafter, the DFT-based PUCCH format will be referred to as PUCCH Format 3.

FIG. 29 illustrates an exemplary structure of PUCCH Format 3 using an OC with SF=4. Referring to FIG. 29, a channel coding block channel-encodes transmission bits a_0, a_1, . . . , a_M−1 (e.g. multiple ACK/NACK bits), thus creating coded bits (or a codeword), b_0, b_1, . . . , b_N−1. M is the size of transmission bits and N is the size of coded bits. The transmission bits include UCI, for example, multiple ACKs/NACKs for a plurality of data (or PDSCHs) received on a plurality of DL CCs. Herein, the transmission bits a_0, a_1, . . . , a_M−1 are jointly encoded irrespective of the type, number, or size of UCI that forms the transmission bits. For example, if the transmission bits include multiple ACKs/NACKs for a plurality of DL CCs, channel coding is performed on the entire bit information, rather than per DL CC or per ACK/NACK bit. A single codeword is generated by channel coding. Channel coding includes, without being limited to, repetition, simplex coding, RM coding, punctured RM coding, Tail-Biting Convolutional Coding (TBCC), Low-Density Parity-Check (LDPC) coding, or turbo coding. While not shown, the coded bits may be rate-matched, taking into account modulation order and the amount of resources. The rate matching function may be incorporated into the channel coding block or implemented in a separate functional block. For example, the channel coding block may produce a single codeword by performing (32, 0) RM coding on a plurality of pieces of control information and may subject the single codeword to cyclic buffer rate-matching.

A modulator generates modulation symbols c_0, c_1, . . . , c_L−1 by modulating the coded bits b_0, b_1, . . . , b_M−1. L is the size of modulation symbols. A modulation scheme is performed by changing the amplitude and phase of a transmission signal. The modulation scheme may be n-Phase Shift Keying (n-PSK) or n-Quadrature Amplitude Modulation (QAM) (n is 2 or a larger integer). More specifically, the modulation scheme may be BPSK, QPSK, 8-PSK, QAM, 16-QAM, or 64-QAM.

A divider divides the modulation symbols c_0, c_1, . . . , c_L−1 into slots. The order/pattern/scheme of dividing modulation symbols into slots is not limited to a specific one. For instance, the divider may divide the modulation symbols into slots, sequentially starting from the first modulation symbol (localized scheme). In this case, the modulation symbols c_0, c_1, . . . , c_L/2−1 may be allocated to slot 0 and the modulation symbols c_L/2, c_L/2+1, . . . , c_L−1 may be allocated to slot 1. When the modulation symbols are allocated to the slots, they may be interleaved (or permuted). For example, even-numbered modulation symbols may be allocated to slot 0 and odd-numbered modulation symbols may be allocated to slot 1. Division may precede modulation.

A DFT precoder performs DFT precoding (e.g. 12-point DFT) on the modulation symbols allocated to the slots in order to generate a single carrier waveform. Referring to FIG. 29, the modulation symbols c_0, c_1, . . . , c_L/2−1 allocated to slot 0 are DFT-precoded to d_0, d_1, . . . , d_L/2−1 and the modulation symbols c_L/2, c_L/2+1, . . . , c_L−1 allocated to slot 1 are DFT-precoded to d_L/2, d_L/2+1, . . . , d_L−1. DFT precoding may be replaced with another linear operation (e.g. Walsh precoding).

A spreading block spreads DFT signals at an SC-FDMA symbol level (in the time domain). The SC-FDMA symbol-level time-domain spreading is performed using a spreading code (sequence). The spreading code includes a quasi-orthogonal code and an orthogonal code. The quasi-orthogonal code includes, without being limited to, a PN (Pseudo Noise) code. The orthogonal code includes, without being limited to, a Walsh code and a DFT code. While an orthogonal code is taken as a main example of the spreading code herein for convenience, the orthogonal code may be replaced with a quasi-orthogonal code. The maximum value of a spreading code size (or a Spreading Factor (SF)) is limited by the number of SC-FDMA symbols used to transmit control information. For example, if four SC-FDMA symbols carry control information in one slot, an orthogonal code of length 4, w0, w1, w2, w3 can be used in each slot. The SF means the degree to which control information is spread. The SF may be related to the multiplexing order or antenna multiplexing order of a UE. The SF may be changed to 1, 2, 3, 4, . . . depending on system requirements. An SF may be predefined between a BS and a UE or the BS may indicate an SF to the UE by DCI or RRC signaling. For example, if one of SC-FDMA symbols for control information is punctured to transmit an SRS, a spreading code with a decreased SF (e.g. SF=3 instead of SF=4) may be applied to the control information in a corresponding slot.

A signal generated from the above operation is mapped to subcarriers in a PRB and converted to a time-domain signal by IFFT. A CP is added to the time-domain signal and the resulting SC-FDMA symbols are transmitted through an RF end.

On the assumption that ACKs/NACKs are transmitted for five DL CCs, each operation will be described in greater detail. If each DL CC can deliver two PDSCHs, ACK/NACK bits for the PDSCHs may be 12 bits, including a DTX state. Given QPSK and time spreading with SF=4, the size of a coding block (after rate matching) may be 48 bits. The coded bits are modulated to 24 QPSK symbols and the QPSK symbols are divided into two slots, 12 QPSK symbols for each slot. The 12 QPSK symbols of each slot are converted into 12 DFT symbols by 12-point DFT, spread to four SC-FDMA symbols using an OC with SF=4 in the time domain, and then mapped. Because 12 bits are transmitted on [2 bits×12 subcarriers×8 SC-FDMA symbols], the coding rate is 0.0625 (=12/192). If SF=4, up to four UEs may be multiplexed per PRB.

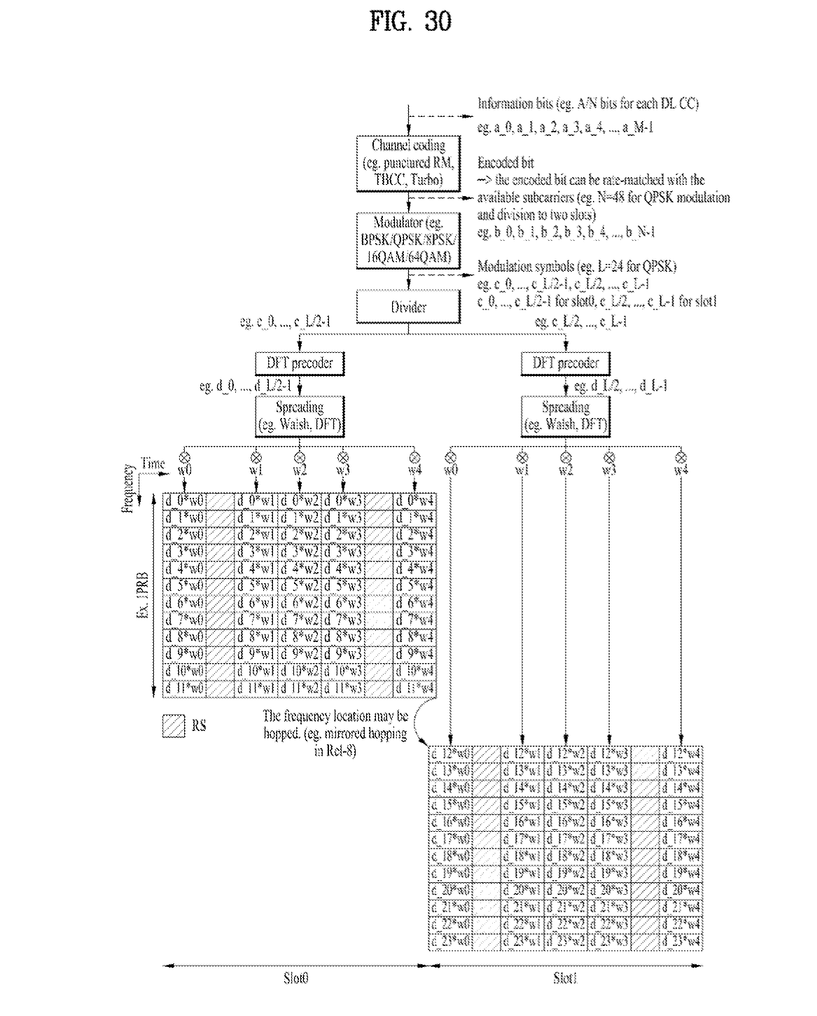

FIG. 30 illustrates an exemplary structure of PUCCH Format 3 using an OC with SF=5.

The basic signal processing operation is performed in the same manner as described with reference to FIG. 29 except for the number and positions of UCI SC-FDMA symbols and RS SC-FDMA symbols. A spreading block may be generated in advance at the front end of a DFT precoder.

In FIG. 30, RSs may be configured in the same configuration as used in the LTE system. For example, a base sequence may be cyclically shifted. The multiplexing capacity of a data part is 5 in view of SF=5. However, the multiplexing capacity of an RS part is determined by a CS interval Δ_{shift}^{PUCCH}. For example, given a multiplexing capacity of 12/Δ_{shift}^{PUCCH}, the multiplexing capacities for the cases where Δ_{shift}^{PUCCH}=1, Δ_{shift}^{PUCCH}=2, and Δ_{shift}^{PUCCH}=3 are respectively 12, 6, and 4. In FIG. 30, while the multiplexing capacity of the data part is 5 due to SF=5, the multiplexing capacity of the RS part is 4 in case of Δ_{shift}^{PUCCH}. Therefore, overall multiplexing capacity may be limited to the smaller of the two values, 4.

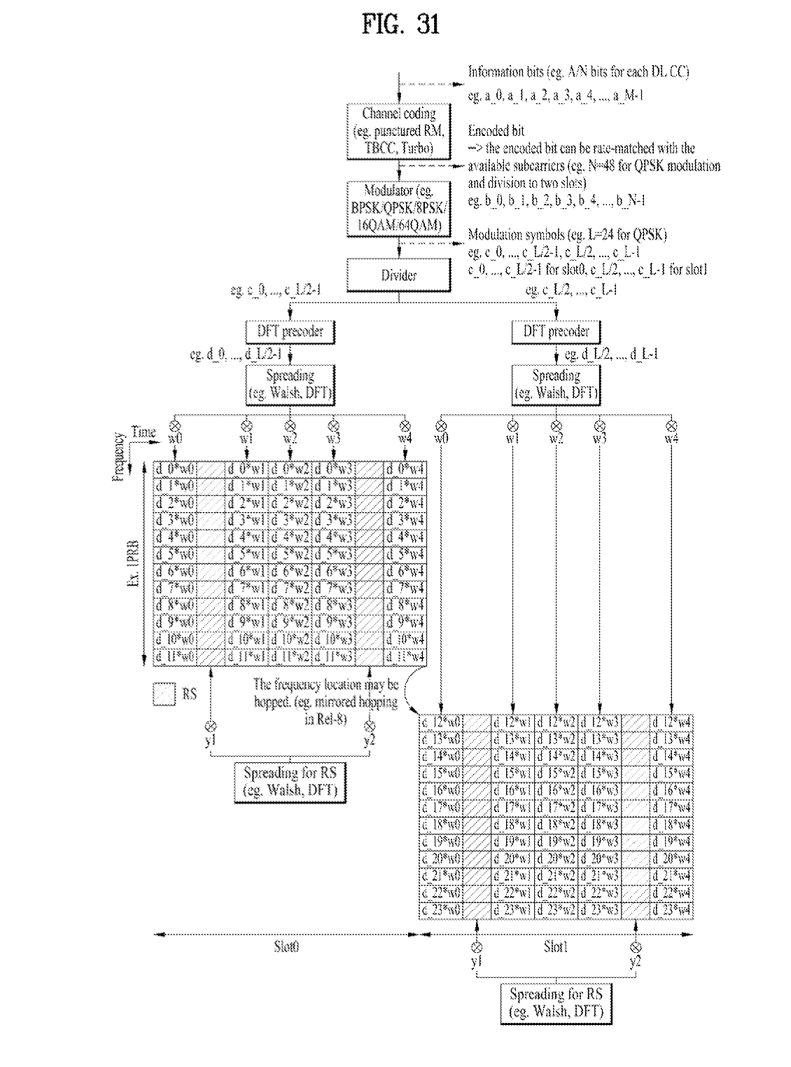

FIG. 31 illustrates an exemplary structure of PUCCH Format 3 that can increase a multiplexing capacity at a slot level.

Overall multiplexing capacity can be increased by applying SC-FDMA symbol-level spreading described with reference to FIGS. 29 and 30 to RSs. Referring to FIG. 31, the multiplexing capacity is doubled by applying a Walsh cover (or a DFT code cover) within a slot. As a consequence, the multiplexing capacity is 8 even in case of Δ_{shift}^{PUCCH}, thereby preventing a decrease in the multiplexing capacity of a data part. In FIG. 31, an OC for RSs may be [y1 y2]=[1 1], [y1 y2]=[1 −1], or their modification (e.g. [j j] [j −j], [1 j] [1 −j], etc.).

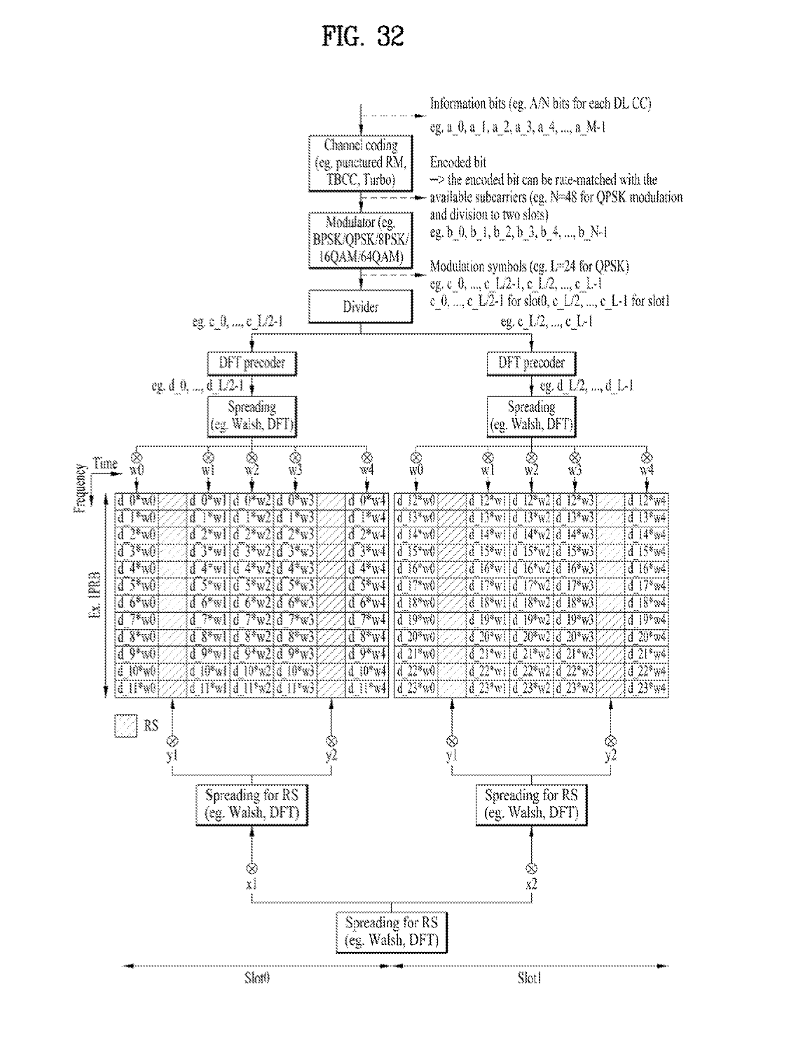

FIG. 32 illustrates an exemplary structure of PUCCH Format 3 that can increase a multiplexing capacity at a subframe level.

Without slot-level frequency hopping, use of a Walsh cover on a slot basis can further double a multiplexing capacity. As described before, [x1 x2]=[1 1], [1 −1], or a modification thereof may be used as an OC.

For reference, the processing operation of PUCCH Format 3 is not limited to the orders illustrated in FIGS. 29 to 32.

A detailed description will be given of an operation of a UE to report control information in a multi-carrier system or a CA system.

While a UE reports control information taking into account a single layer and a single CC in the legacy system, a multi-carrier system or a CA system requires an effective method to support a plurality of CCs.

Accordingly, the present invention provides a method for multiplexing or coding control information to effectively support a plurality of component carriers.

While a description will be given on the assumption that control information is ACK/NACK information for convenience, the present invention is not limited thereto.

When ACK/NACK information and SR (Scheduling Request) information are transmitted in the same subframe, a UE can transmit bundled ACK/NACK information or an ACK/NACK response to a BS through an ACK/NACK PUCCH resource allocated thereto for negative SR (Negative Scheduling Request: a case in which scheduling request is not needed) information. For positive SR (Positive Scheduling Request: a case in which scheduling request is needed) information, the UE transmits ACK/NACK information allocated to an SR PUCCH resource using PUCCH Format 1b.

Herein, the UE may generate information corresponding to the number of ACKs for a PDCCH by spatial-bundling ACK/NACK information for a plurality of codewords related to transmission of each PDSCH.

This will be described with reference to Table 11.

TABLE 11

| Number of ACK among multiple | |
|---|---|
| (U_{DAI} + N_{SPS}) | |
| ACK/NACK responses | b(0), b(1) |
| 0 or none (UE detects at least | 0, 0 |
| one DL assignment is missed) | |
| 1 | 1, 1 |
| 2 | 1, 0 |
| 3 | 0, 1 |
| 4 | 1, 1 |
| 5 | 1, 0 |
| 6 | 0, 1 |
| 7 | 1, 1 |
| 8 | 1, 0 |
| 9 | 0, 1 |

In Table 11, b(0), b(1) denotes binary transmission bits transmitted using a selected PUCCH resource. Bits b(0), b(1) may be mapped to complex symbols through QPSK and transmitted to the BS using a PUCCH resource.

The binary transmission bits b(0), b(1) can represent four cases, and thus overlapped values of b(0), b(1) may be used when more than four events are present.

While Table 11 simply shows responses to ACK information, the responses may be responses to other factors. For example, the responses may be responses to a plurality of CCs, responses to a plurality of codewords, or responses to a combination thereof.

Referring to Table 11, when the number of ACKs is 0, the UE does not receive data, or the UE processes the situation as a state in which no data is received according to a predetermined rule, b(0), b(1) is (0,0).

When the number of ACKs is 1, 2, 3, 4, 5, 6, 7, 8 and 9, b(0), b(1) is (1,1), (1,0), (0,1), (1,1), (1,0), (0,1), (1,1), (1,0) and (0,1).

In this case, since b(0), b(1) overlaps, an error may be generated. For example, if the BS transmits four PDSCHs to the UE and receives information on the number of ACKs, (1,1) from the UE, the BS can consider two situations. That is, the BS can recognize that the UE has successfully decoded only one PDSCH upon considering (1,1) to indicate one ACK or recognize that the UE has successfully decoded all the four PDSCHs upon considering (1,1) to indicate four ACKs.

If the BS does not transmit additional information even when the UE has successfully decoded only one PDSCH, the BS may misrecognize that all the PDSCHs have been successfully transmitted.

The present invention provides a method for transmitting the number of ACKs per codeword included in each CC to transmit control information precisely.

Hereinafter, the number of ACKs is referred to as ACK counter. The ACK counter may refer to the number of all non-consecutive ACKs among entire ACK information, or may refer to only the number of consecutive ACKs counted from preceding ACK information among the entire ACK information.

On the assumption that each DL CC can carry up to two codewords, the UE can transmit an ACK counter for each of two codewords included in each CC.

CCs may respectively carry different numbers of codewords. For example, the first of two CCs can carry two codewords and the second can carry one codeword.

To solve this problem, the present invention proposes two methods of calculating an ACK counter for the second CC according to a predetermined rule.

According to the first method, an ACK counter for each CC depends on the maximum number of codewords set for each CC. Specifically, when up to two codewords are set in a specific CC for a BS, even if a specific PDCCH uses only one codeword in the CC, an ACK counter is set to 2 which corresponds to the maximum number of codewords included in the CC. That is, the ACK counter is determined by considering information about the second codeword to be ACK or NACK information according to a predetermined rule.

For instance, it is assumed that two CC are set, the first CC uses two codewords, the second CC uses one codeword, information included in the codeword of the second CC is ACK information.

In this case, since the second CC uses one codeword smaller than 2 corresponding to the maximum number of codewords, it can be considered that the remaining codeword includes NACK information according to the predetermined rule.

That is, the second CC is considered to include ACK information and NACK information and an ACK counter indicating this is transmitted.

Alternatively, an ACK counter may be counted according to whether ACK information included in a predetermined CC makes a pair with ACK information included in a different CC.

For example, it is assumed that, among two CCs, the first CC uses two codewords, the second CC uses one codeword, the two codewords of the first CC include ACK information and NACK information and the codeword of the second CC includes ACK information.

In this case, the ACK information corresponding to the first codeword of the first CC pairs with the ACK information corresponding to the codeword of the second CC, whereas the NACK information corresponding to the second codeword of the first CC does not make a pair since the second CC uses only one codeword, and thus an ACK counter having a value of b(0), b(1)=(2,0) is calculated.

The following description will be given on the assumption that an ACK counter for each CC is calculated depending on the maximum number of codewords set for each CC according to the first method and transmitted per codeword included in each CC.

When five CCs are set and carry information in a multi-carrier CA system and up to two codewords are included in each CC, up to 11 pieces of information including DTX information can be transmitted. That is, 5 (the number of CCs)×2 (the number of codewords included in each CC)+1 (the number of DTX)=11.

This information can be transmitted through QPSK as described with reference to Table 11. In this case, binary transmission bits are also used. Since the number of QPSK constellation points represented by the binary transmission bits is 4, a plurality of information is mapped to be overlapped.

Table 12 lists exemplary binary transmission bits.

TABLE 12

| | Number of ACK among multiple | |
|---|---|---|
| | (U_{DAI} + N_{SPS}) | |
| No. | ACK/NACK responses | b(0), b(1) |
| 0 | UE fails in decoding any one | 0, 0 |
| | of the DL assignments | |
| 1 | (0, 1) or (1, 1) or (2, 1) or (3, 1) or (4, 1) or (5, 1) | 0, 1 |
| 2 | (0, 2) or (1, 2) or (2, 2) or (3, 2) or (4, 2) or (5, 2) | 1, 0 |
| 3 | (0, 3) or (1, 3) or (2, 3) or (3, 3) or (4, 3) or (5, 3) | 1, 1 |
| 4 | (0, 4) or (1, 4) or (2, 4) or (3, 4) or (4, 4) or (5, 4) | 0, 0 |
| 5 | (0, 5) or (1, 5) or (2, 5) or (3, 5) or (4, 5) or (5, 5) | 0, 1 |

Here, b(0), b(1) are binary transmission bits transmitted using a selected PUCCH resource, as in Table 11. The binary transmission bits b(0), b(1) may be mapped to complex symbols through QPSK modulation and transmitted to a BS using a PUCCH resource.

In addition, (a, b) denotes ACK counters for five CCs, a in (a, b) denotes an ACK counter for the first codeword included in each CC, and b denotes an ACK counter for the second codeword included in each CC.

However, values of (a, b) and b(0), b(1) listed in Table 12 are exemplary and the present invention is not limited thereto.

While description is given on the assumption that the UE transmits the ACK counter, the present invention is applicable to other types of information. That is, values which can be included in Table 12 may include constellation values according to modulation (e.g. BPSK or QPSK) on a specific channel, values multiplied by a sequence, scrambled values or covered values.

Even in this case, the binary transmission bits are used and thus the number of QPSK constellation points represented by the binary transmission bits is 4 and a plurality of overlapped information is transmitted. Accordingly, it is difficult for the BS to effectively control transmission of overlapped information.

To reduce transmission of overlapped information, the present invention proposes a method of transmitting an ACK counter using channel selection. The method of transmitting the ACK counter using channel selection includes allocating a plurality of channels, selecting at least one of the allocated channels, and transmitting an ACK counter on the selected channel.

For example, if N PUCCHs are allocated and an ACK counter is transmitted using channel selection, the amount of overlapped information can be reduced up to N times. The PUCCH channels can be interchangeably referred to as PUCCH resources.

This is illustrated in Table 13.

TABLE 13

| | Number of ACK among multiple | PUCCH | |
|---|---|---|---|
| | (U_{DAI} + N_{SPS}) | resource | |
| No. | ACK/NACK responses | (0 or 1) | b(0), b(1) |
| 0 | UE fails in decoding any one | 0 | 0, 0 |
| | of the DL assignments | | |
| 1 | (0, 1) or (1, 1) or (2, 1) or (3, 1) | 0 | 0, 1 |
| 2 | (0, 2) or (1, 2) or (2, 2) or (3, 2) | 0 | 1, 0 |
| 3 | (0, 3) or (1, 3) or (2, 3) or (3, 3) | 0 | 1, 1 |
| 4 | (0, 4) or (1, 4) or (2, 4) or (3, 4) | 1 | 0, 0 |
| 5 | (0, 5) or (1, 5) or (2, 5) or (3, 5) | 1 | 0, 1 |
| 6 | (4, 1) or (4, 2) or (4, 3) or (4, 4) or (4, 5) | 1 | 1, 0 |
| 7 | (5, 1) or (5, 2) or (5, 3) or (5, 4) or (5, 5) | 1 | 1, 1 |

Assumption for Table 12 is equally applied to Table 13.

In Table 13, it is assumed that two PUCCH resources are used, and the two PUCCH resources are indicated by 0 or 1 respectively.

Compared to Table 12, the number of (a, b) corresponding to each b(0), b(1) is reduced and the number of the entire representations is increased from 6 to 8, and thus it will be appreciated that it is advantageous in reducing transmission of overlapped information.

The values of (a, b), PUCCH resource, and b(0), b(1) in Table 13 are exemplary and the resource mapping method of the present invention is not limited thereto.

According to an embodiment of the present invention, a method of using RS selection in a specific channel to reduce transmission of overlapped information may be provided.

RS selection is distinguished from channel selection in that a plurality of PUCCH channels is not necessary.

That is, the channel selection method requires one or more PUCCH channels, which may increase resource overhead. The RS selection method can indicate a plurality of pieces of information including no overlapped information using RS information in a specific channel without increasing resource overhead.

For example, an ACK counter can be transmitted by an RS selection method using two RS modulated symbols. This is illustrated in Table 14.

TABLE 14

| | Number of ACK among multiple | | |
|---|---|---|---|
| | (U_{DAI} + N_{SPS}) | RS | |
| No. | ACK/NACK responses | (0 or 1) | B(0), b(1) |
| 0 | UE fails in decoding any one | 0 | 0, 0 |
| | of the DL assignments | | |
| 1 | (0, 1) or (1, 1) or (2, 1) or (3, 1) | 0 | 0, 1 |
| 2 | (0, 2) or (1, 2) or (2, 2) or (3, 2) | 0 | 1, 0 |
| 3 | (0, 3) or (1, 3) or (2, 3) or (3, 3) | 0 | 1, 1 |
| 4 | (0, 4) or (1, 4) or (2, 4) or (3, 4) | 1 | 0, 0 |
| 5 | (0, 5) or (1, 5) or (2, 5) or (3, 5) | 1 | 0, 1 |
| 6 | (4, 1) or (4, 2) or (4, 3) or (4, 4) or (4, 5) | 1 | 1, 0 |
| 7 | (5, 1) or (5, 2) or (5, 3) or (5, 4) or (5, 5) | 1 | 1, 1 |

It is assumed that assumption for Table 12 is equally applied to Table 14.

In Table 14, it is assumed that two RS modulated symbols are used, and the two RS are indicated by 0 or 1 respectively.

Compared to Table 12, the number of ACKs, (a, b), included in each b(0), b(1) is reduced and the total number of representations of the number of ACKs increases from 6 to 8, and thus it is possible to appreciate the advantage of reduction of transmission of overlapped information.

The values of (a, b), RS, and b(0), b(1) in Table 14 are exemplary and the resource mapping method of the present invention is not limited thereto.

The present invention provides an enhanced channel selection method corresponding to a combination of the RS selection method and the channel selection method.

Referring to Tables 13 and 14, while the amount of overlapped information is reduced through RS selection or channel selection, overlapped information is still frequently transmitted.

Accordingly, the present invention provides an enhanced channel selection method for efficient information transmission.

General channel selection is performed according to information to be transmitted using a plurality of constellations, resources (e.g. physical time-frequency resources) and/or codes (including cyclic shift).

Here, RS information is selected regardless of the selection performed by channel selection or selected simultaneously with the selection. That is, the RS information is not used for information transmission according to channel selection.

The present invention proposes an enhanced channel selection method that uses the RS information for channel selection. That is, a larger amount of information is transmitted by using the RS information for channel selection.

For example, when an ACK counter is transmitted using enhanced channel selection that uses two PUCCH resources and two RSs, the quantity of overlapped information can be reduced up to four times.

This is illustrated by way of Table 15.

TABLE 15

| | Number of ACK among multiple | PUCCH | | |
|---|---|---|---|---|
| | (U_{DAI} + N_{SPS}) | resource | RS | |
| No. | ACK/NACK responses | (0 or 1) | (0 or 1) | b(0), b(1) |
| 0 | UE fails in decoding any one | 0 | 0 | 0, 0 |
| | of the DL assignments | | | |
| 1 | (0, 1) or (1, 1) | 0 | 0 | 0, 1 |
| 2 | (0, 2) or (1, 2) | 0 | 0 | 1, 0 |
| 3 | (0, 3) or (1, 3) | 0 | 0 | 1, 1 |
| 4 | (0, 4) or (1, 4) | 1 | 0 | 0, 0 |
| 5 | (0, 5) or (1, 5) | 1 | 0 | 0, 1 |
| 6 | (2, 1) or (3, 1) | 1 | 0 | 1, 0 |
| 7 | (2, 2) or (3, 2) | 1 | 0 | 1, 1 |
| 8 | (2, 3) or (3, 3) | 0 | 1 | 0, 0 |
| 9 | (2, 4) or (3, 4) | 0 | 1 | 0, 1 |
| 10 | (2, 5) or (3, 5) | 0 | 1 | 1, 0 |
| 11 | (4, 1) or (5, 1) | 0 | 1 | 1, 1 |
| 12 | (4, 2) or (5, 2) | 1 | 1 | 0, 0 |
| 13 | (4, 3) or (5, 3) | 1 | 1 | 0, 1 |
| 14 | (4, 4) or (5, 4) | 1 | 1 | 1, 0 |
| 15 | (4, 5) or (5, 5) | 1 | 1 | 1, 1 |

Assumption for Table 12 is equally applied to Table 15.

In Table 15, it is assumed that two PUCCH resources are used and indicated by 0 or 1 and two RS modulated symbols are used and indicated by 0 or 1.

Compared to Table 12, the number of ACKs, (a, b), corresponding to each b(0), b(1) is remarkably reduced and the number of representations of the number of ACKs increases to 16 from 6, and thus it is possible to appreciate the advantage of reduction of transmission of overlapped information.

As described above, enhanced channel selection is superior to RS selection or channel selection since the enhanced channel selection can reduce a larger amount of overlapped information than RS selection or channel selection.

The values of (a, b), PUCCH resource, RS, and b(0), b(1) in Table 15 are exemplary and the resource mapping method of the present invention is not limited thereto.

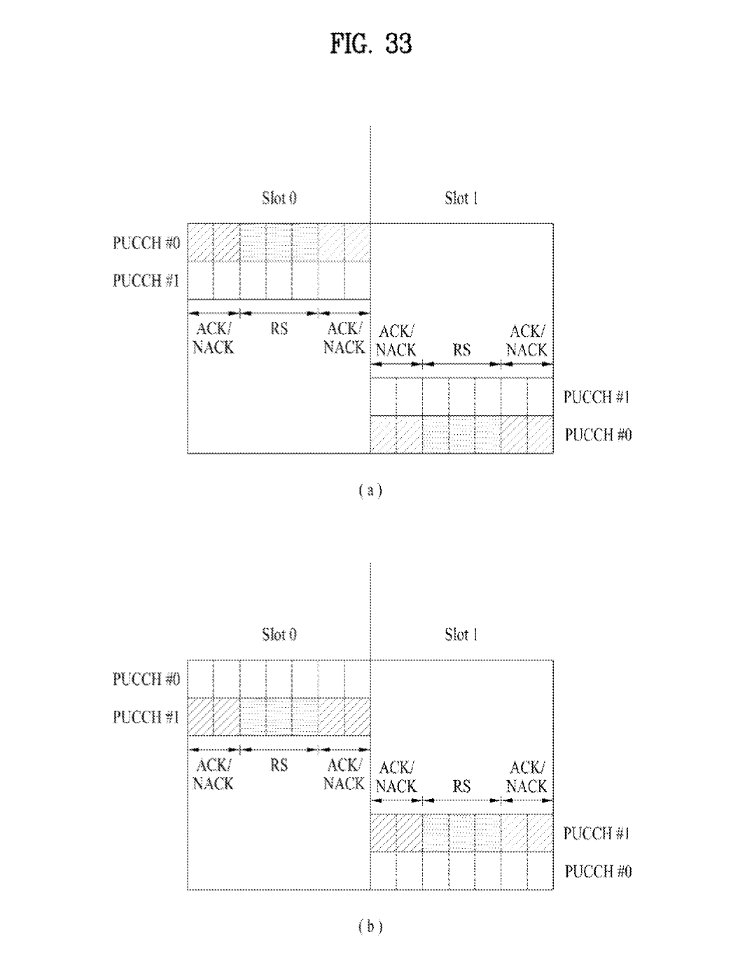

FIG. 33 illustrates an ACK/NACK information transmission structure based on channel selection, to which the present invention is applied. Referring to FIG. 33, two PUCCH resources or PUCCH channels (PUCCH resource #0 and PUCCH resource #1 or PUCCH channel #0 and PUCCH channel #1) may be configured in PUCCH Format 1b for 2-bit ACK/NACK information.

In the case of transmitting 3-bit ACK/NACK information, 2 bits of the 3-bit ACK/NACK information may be represented by PUCCH Format 1b and the other 1 bit of the 3-bit ACK/NACK information may be represented according to a PUCCH resource selected from the two PUCCH resources. For example, since the 1 bit can be indicated by whether ACK/NACK information is transmitted via PUCCH resource #0 or via PUCCH resource #1 (two cases) can indicates 1 bit, a total of 3 ACK/NACK bits may be represented.

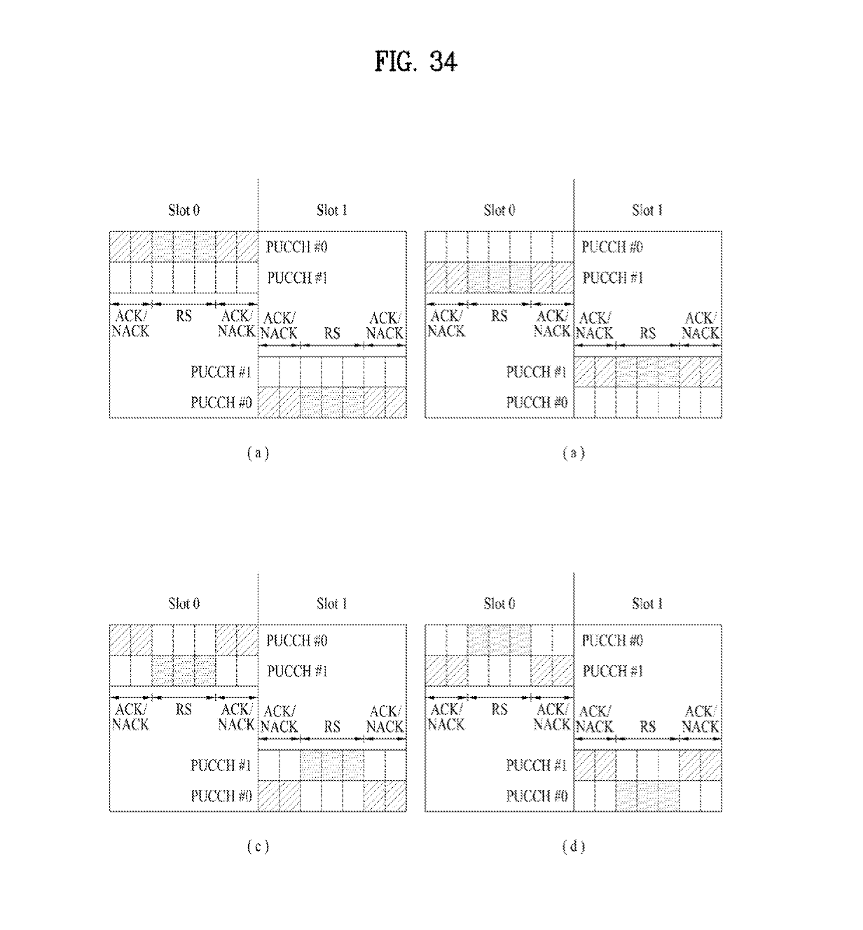

FIG. 34 illustrates an ACK/NACK information transmission structure based on enhanced channel selection, to which the present invention is applied. While PUCCH #0 and PUCCH #1 are allocated to different time/frequency regions in FIG. 34 for convenience of description, different codes may be used in the same time/frequency region. Referring to FIG. 34, two PUCCH resources (PUCCH resource #0 and PUCCH resource #1) may be configured for PUCCH Format 1a of transmitting 1-bit ACK/NACK information.

In case of transmitting 3-bit ACK/NACK information, one bit of the 3-bit ACK/NACK information may be represented by PUCCH Format 1a, another one bit of the 3-bit ACK/NACK information may be represented by which PUCCH resource (PUCCH resource #0 or PUCCH resource #1) carries the ACK/NACK information, and the other one bit of the 3-bit ACK/NACK information may be represented by a resource carrying an RS. While the RS is preferably transmitted in the time/frequency regions of the selected PUCCH resource (PUCCH resources #0 and #1), the RS may be transmitted in the time/frequency region corresponding to an original PUCCH resource for the RS.

That is, 2 bits (4 cases) can be represented by selecting one of the case where ACK/NACK information is transmitted via PUCCH resource #0 and an RS is transmitted in a resource corresponding to PUCCH resource #0, the case where ACK/NACK information is transmitted via PUCCH resource #1 and an RS is transmitted in a resource corresponding to PUCCH resource #1, the case where ACK/NACK information is transmitted via PUCCH resource #0 and an RS is transmitted in a resource corresponding to PUCCH resource #1, and the case where ACK/NACK information is transmitted via PUCCH resource #1 and an RS is transmitted in a resource corresponding to PUCCH resource #0. In this manner, 3-bit ACK/NACK information may be represented.

While it has been described that two PUCCH resources are configured to transmit 3-bit ACK/NACK information in FIGS. 33 and 34, by way of example, the number of transmission bits of ACK/NACK information and the number of PUCCH resources may vary. It will be appreciated that the same principle can be applied to the case where UCI other than ACK/NACK information or both ACK/NACK information and other UCI are transmitted.

While ACK/NACK information and RS information are discriminated in PUCCH in enhanced channel selection, the ACK/NACK information and the RS information are transmitted at the same physical time and frequency, that is, in the same PRB. More specifically, the RS information is transmitted and discriminated through different codes at the same physical position.

the present invention may be applied by signaling to a UE through higher layer configuration, or the present invention may be applied to the UE in a predetermined situation. For example, when a simultaneous transmission of SR and ACK/NACK occurs in the same subframe, an ACK counter may be transmitted using a plurality of PUCCH resources including an SR PUCCH as in the embodiment of the present invention.

The above-described embodiments of the present invention can be implemented to transmit various types of UCI. The same principle can be applied to variation of the numbers of SR information and ACK/NACK information. In addition, other control information transmission methods can be contemplated by combining a plurality of embodiments. It is obvious that bit transmission according to an embodiment of the present invention can be applied to transmission of control information according to various embodiments of the present invention.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

In the embodiments of the present invention, a description is given centering on a data transmission and reception relationship among a BS and a UE. In some cases, a specific operation described as performed by the BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with the term, fixed station, Node B, ‘eNode B (eNB), access point, etc. The term ‘terminal’ may be replaced with the terms UE, MS, Mobile Subscriber Station (MSS), etc.

The embodiments of the present invention may be achieved by various means, for example, hardware, firmware, software, or a combination thereof. In a hardware configuration, an embodiment of the present invention may be achieved by one or more ASICs, DSPs, DSDPs, PLDs, FPGAs, processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

Although the above-described method and apparatus for transmitting control information in a wireless communication system according to the present invention are applied to 3GPP LTE in the above description, they are applicable to various wireless communication systems in addition to 3GPP system.

1. A method for a user equipment (UE) to transmit control information to a base station (BS) in a wireless communication system, the method comprising:
receiving a plurality of transport blocks from the BS via at least one serving cell configured for the UE; and
transmitting first control information regarding the received transport blocks to the BS,
wherein each of the at least one serving cell carries one or more transport blocks, and the first control information is information regarding each of the one or more transport blocks included in each of the at least one serving cell.

2. The method of claim 1, wherein the first control information is information on a number of positive acknowledgement response (ACK).

3. The method of claim 2, wherein the first control information is information regarding each of a maximum number of transport blocks carried by each of the at least one serving cell and,
when a number of transport blocks carried by a first serving cell from among the at least one serving cell is less than the maximum number of transport blocks, the first control information regarding each of transport blocks other than transport blocks actually carried by the first serving cell from among the maximum number of transport blocks carried by the first serving cell is negative acknowledgement response (NACK) information.

4. The method of claim 3, wherein the maximum number of transport blocks is 2.

5. The method of claim 1, wherein the transmitting the first control information to the BS comprises:
selecting a PUCCH resource for the first control information from a plurality of PUCCH resources; and
transmitting a PUCCH signal carrying a modulation value corresponding to the first control information through the selected PUCCH resource,
wherein the first control information is identified by a combination of the selected PUCCH resource and the modulation value.

6. The method of claim 1, wherein the transmitting of the first control information to the BS comprises:
transmitting a PUCCH signal carrying a modulation value corresponding to the first control information through a PUCCH resource; and
transmitting a reference signal for demodulation of the PUCCH signal,
wherein the first control information is identified by a combination of the modulation value and a resource for the reference signal.

7. The method of claim 1, wherein the transmitting of the first control information to the BS comprises:
selecting a PUCCH resource for the first control information from a plurality of PUCCH resources;
transmitting a PUCCH signal carrying a modulation value corresponding to the first control information through the selected PUCCH resource; and
transmitting a reference signal for demodulation of the PUCCH signal,
wherein the first control information is identified by a combination of the selected PUCCH resource, the modulation value and a resource for the reference signal.

8. A UE for transmitting control information to a BS in a wireless communication system, the UE comprising:
a receiver for receiving a plurality of transport blocks from the BS via at least one serving cell configured for the UE; and
a transmitter for transmitting first control information regarding the received transport blocks to the BS,
wherein each of the at least one serving cell carries one or more transport blocks, and the first control information is information regarding each of the one or more transport blocks included in each of the at least one serving cell.

9. The UE of claim 8, wherein the first control information is information on a number of positive acknowledgement response (ACK).

10. The UE of claim 9, further comprising a processor,
wherein the first control information is information regarding each of a maximum number of transport blocks carried by the at least one serving cell and,
when a number of transport blocks carried by a first serving cell from among the at least one serving cell is less than the maximum number of transport blocks, the processor controls the first control information regarding each of transport blocks other than transport blocks actually carried by the first serving cell from among a maximum number of transport blocks carried by the first serving cell to be negative acknowledgement response (NACK) information.

11. The UE of claim 10, wherein the maximum number of transport blocks is 2.

12. The UE of claim 8, wherein the processor selects a PUCCH resource for the first control information from a plurality of PUCCH resources, and controls a PUCCH signal carrying a modulation value corresponding to the first control information to be transmitted through the selected PUCCH resource,
wherein the first control information is identified by a combination of the selected PUCCH resource and the modulation value.

13. The UE of claim 8, wherein the processor transmits a PUCCH signal carrying a modulation value corresponding to the first control information through a PUCCH resource via the transmitter and controls a reference signal for demodulation of the PUCCH signal to be transmitted through the transmitter,
wherein the first control information is identified by a combination of the modulation value and a resource for the reference signal.

14. The UE of claim 8, wherein the processor selects a PUCCH resource for the first control information from a plurality of PUCCH resources, transmits a PUCCH signal carrying a modulation value corresponding to the first control information through the selected PUCCH resource via the transmitter, and controls a reference signal for demodulation of the PUCCH signal to be transmitted through the transmitter, wherein the first control information is identified by a combination of the selected PUCCH resource, the modulation value and a resource for the reference signal.
